(19) United States
(12) Patent Application Publication
(10) Pub. No.: US 2007/0010400 A1
(43) Pub. Date: Jan. 11, 2007

(54) Use of color changing indicators in consumer products

(76) Inventors: Ram W. Sabnis, Eagan, MN (US); Timothy D. Kehoe, St. Paul, MN (US); Robert James Balchunis, St. Paul, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/474,518

(22) Filed: Jun. 23, 2006

Related U.S. Application Data
(60) Provisional application No. 60/696,872, filed on Jul. 6, 2005.
(60) Provisional application No. 60/711,183, filed on Aug. 25, 2005.

(51) Int. Cl. A01N 25/00

(52) U.S. Cl. 504/116.1

(57) ABSTRACT

The invention describes uses of various acid-base indicators in combination with consumer products, such as herbicides, where upon application the surface treated is visualized by color and then, with time, the color disappears.

### CROSS REFERENCE TO RELATED APPLICATIONS

This application claims benefit under 35 U.S.C. §119(e) to U.S. Ser. Nos. 60/696,872, filed Jul. 6, 2005 (Attorney docket number 186573/US), entitled “Color Changing Compositions and Articles” and 60/711,183, filed Aug. 25, 2005 (Attorney docket number 186978/US), entitled “Substituted Phenol-Based Aqueous Indicators.

### FIELD OF THE INVENTION

The invention relates generally use of acid-base indicators to indicate when and where a surface has been treated.

### BACKGROUND OF THE INVENTION

It is often difficult to visualize when and/or where a surface has been treated with a substance due to poor contrast, poor lighting or a myriad of other factors. Generally, it is desirable to treat the intended surface so that the treatment is uniform. It is often difficult to establish that this has been accomplished and whether if the treatment was effective.

For example, some herbicides are a clear liquid, thus not providing the ability to easily identify where treatment has occurred. Some car polishes provide a superb finish, but it is often difficult to discern where the polish was applied. As another example, if can be difficult to determine whether automatic car washes provide complete coverage for the entire vehicle without some visual indicator to indicate so.

Therefore, a need exists for new compositions and articles that address one or more of the noted weaknesses with available technology.

### BRIEF SUMMARY OF THE INVENTION

The invention provides various compositions that includes an acid-base indicator, a carrier of some type (a solvent, wax, emulsifier, etc.), and one or more additional ingredients. Such compositions include herbicides, carpet cleaners (spot cleaners), liquid plant food, dog/cat sprays (for fleas, ticks, etc.), fabric freshener, liquid bandages, glass/window cleaner, car wax, car wash concentrate and leather cleaners.

Typically the acid-base indicator is (I):

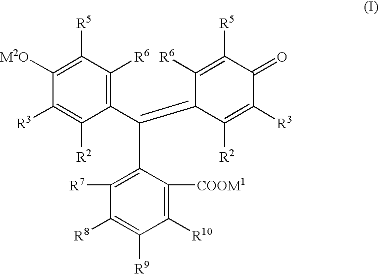

wherein R², R³, R⁵, R⁶, R⁷, R⁸, R⁹ and R¹⁰ are each, independently of one another, selected from the group consisting of hydrogen, —OH, —SH, —CN, —NO₂, halo, fluoro, chloro, bromo, iodo, lower alkyl, substituted lower alkyl, lower heteroalkyl, substituted lower heteroalkyl, cycloalkyl, substituted cycloalkyl, cycloheteroalkyl, substituted cycloheteroalkyl, lower haloalkyl, monohalomethyl, dihalomethyl, trihalomethyl, trifluoromethyl, lower alkylthio, substituted lower alkylthio, lower alkoxy, substituted lower alkoxy, methoxy, substituted methoxy, lower heteroalkoxy, substituted lower heteroalkoxy, cycloalkoxy, substituted cycloalkoxy, cycloheteroalkoxy, substituted cycloheteroalkoxy, lower haloalkoxy, monohalomethoxy, dihalomethoxy, trihalomethoxy, trifluoromethoxy, amino, lower di- or monoalkylamino, substituted lower di- or monoalkylamino, aryl, substituted aryl, aryloxy, substituted aryloxy, phenoxy, substituted phenoxy, arylalkyl, substituted arylalkyl, arylalkyloxy, substituted arylalkyloxy, benzyl, benzyloxy, heteroaryl, substituted heteroaryl, heteroaryloxy, substituted heteroaryloxy, heteroarylalkyl, substituted heteroarylalkyl, heteroarylalkyloxy, substituted heteroarylalkyloxy, carboxyl, lower alkoxycarbonyl, substituted lower alkoxycarbonyl, aryloxycarbonyl, substituted aryloxycarbonyl, arylalkyloxycarbonyl, substituted arylalkyloxycarbonyl, carbamate, substituted carbamate, carbamoyl, substituted carbamoyl, sulfamoyl or substituted sulfamoyl.

Alternatively, R² and R³, R⁵ and R⁶ or R² and R³, and R⁵ and R⁶ can form cyclic ring structures that are heterocyclic, heteroaromatic, aromatic or nonaromatic and can contain one or more heteroatoms to form, for example, a quinoline, napthalene, etc.

Additionally, R⁷ and R⁸, R⁸ and R⁹, R⁹ and R¹⁰ or combinations thereof can form cyclic ring structures that are heterocyclic, heteroaromatic, aromatic or nonaromatic and can contain one or more heteroatoms to form, for example, a quinoline, napthalene, etc.

Optionally, one of the carbons connected to R², R³, R⁵ or R⁶ can be substituted with a nitrogen atom.

M¹ and M² are each independently a hydrogen atom, a metal ion or an ammonium ion.

In certain aspects, compounds are excluded where R², R³, R⁵, R⁶, R⁷, R⁸, R⁹ and R¹⁰ are all hydrogen atoms, or where R² is hydrogen, R³is Me, and R⁵, R⁶, R⁷, R⁸, R⁹ and R¹⁰ are all hydrogen atoms, or where R² is Me, R³ is a hydrogen atom, R⁵ is an iso-propyl group and R⁶, R⁷, R⁸, R⁹ and R¹⁰ are all hydrogen atoms.

In certain embodiments, R² is selected from the group consisting of hydrogen, nitro, amino and alkyl; R³ is selected from the group consisting of hydrogen, phenyl, alkyl, nitro, acetamido and alkoxy; R⁵ is selected from the group consisting of hydrogen, halo, and alkyl; and R⁶ is selected from the group consisting of hydrogen and alkyl.

In certain other embodiments, R² is selected from the group consisting of hydrogen and methyl; R³ is selected from the group consisting of hydrogen, phenyl, isopropyl, methyl, ethyl, sec-butyl, nitro and methoxy; R⁵ is selected from the group consisting of hydrogen, bromo, methoxy, isopropyl and methyl; and R⁶ is selected from the group consisting of hydrogen and methyl.

In other embodiments, R², R³, R⁵, R⁶, R⁷, R⁸, R⁹ and R¹⁰ are all hydrogen atoms, or R² is hydrogen, R³ is Me, and R⁵, R⁶, R⁷, R⁸, R⁹ and R¹⁰ are all hydrogen atoms, or R² is Me, R³ is a hydrogen atom, R⁵ is an iso-propyl group and R⁶, R⁷, R⁸, R⁹ and R¹⁰ are all hydrogen atoms, or R² is H, R³ is Me, R⁵ is Br and R⁶, R⁷, R⁸, R⁹ and R¹⁰ are all hydrogen atoms, or R² is Me, R³ is Br, R⁵ is an isopropyl and R⁶, R⁷, R⁸, R⁹ and R¹⁰ are all hydrogen atoms. In certain embodiments, one or more of these compounds may be excluded from certain aspects of the invention.

In still other embodiments, R² is H, R³ is phenyl and R⁵, R⁶, R⁷, R⁸, R⁹ and R¹⁰ are all hydrogen atoms, or R² is H, R³ and R⁵ are isopropyl and R⁶, R⁷, R⁸, R⁹ and R¹⁰ are all hydrogen atoms, or R² is H, R³is methyl, R⁵ is H, R⁶ is methyl, R⁷, R⁸, R⁹ and R¹⁰ are all hydrogen atoms, or R² is H, R³ and R⁵ are methoxy and R⁶, R⁷, R⁸, R⁹ and R¹⁰ are all hydrogen atoms, or R² is H, R³ and R⁵ are methyl and R⁶, R⁷, R⁸, R⁹ and R¹⁰ are all hydrogen atoms, or R² is H, R³ is ethyl and R⁵, R⁶, R⁷, R⁸, R⁹ and R¹⁰ are all hydrogen atoms, or R² is H, R³ is methoxide and R⁵, R⁶, R⁷, R⁸, R⁹ and R¹⁰ are all hydrogen atoms, or and R², R³ and R⁵ are all methyl and R⁶, R⁷, R⁸, R⁹ and R¹⁰ are all hydrogen atoms, or R², R³, R⁵, R⁶, R⁷, R⁸, R⁹, R¹⁰ are all hydrogen atoms and R³ is sec-butyl, or R², R³, R⁵, R⁶, R⁷, R⁸, R⁹, R¹⁰ are all hydrogen atoms and R³ is nitro.

In particular, at least one of M¹ or M² is a metal or an ammonium ion.

It should be understood, that the salt form of the indicator can be isolated prior to use or prepared in situ. Ideally, the salt is formed as a mono-salt or a di-salt, meaning that excess base is not present and either 1 or 2 equivalents of base react with the acidic protons of the indicator.

### DETAILED DESCRIPTION

The acid-base indicators of the present invention can be used in, but not limited to, a wide variety of fields such as car tire tread marks, infant/baby (spoons, straws), food (alcohol, bubble gum, cakes/pastries, candy, dairy food, decorative ice cubes, food colors, mints, soda/juices, spices/curry), pharmaceuticals (assays for measuring cell proliferation, dental materials/fillings, diagnosis of bacterial infection, diagnosis of tumors, diagnostic reagents, endotracheal intubation device, enzyme assays, laxative, medical equipment, operation theaters, pills, pregnancy test, syrup, treatment of herpes infection), health/beauty (contact lens cleaner, diapers, facial masks, spray on tan, sunscreen), agrochemicals (fertilizers, insecticides, pesticides, plant hormones, weed killer), cleaners (car wash/wax, dusting, floor polish/was, general surface cleaner, glass cleaning), materials (bricks, ceramics, concrete, glass, leather, metals, stones, wood), home/garden (fountain colorant, swimming pool colorant), Security (billing system, safety glasses/goggles, safety masks, scanning machines at the air ports/railway stations/bus station/cargo, security alarm, shipping industry, tag scan, tamper proof labels), semiconductor (antireflective coatings (ARC) for semiconductor processes, dielectric coatings, photo-resists, sensors (fiber optic sensors for measuring fluid parameters especially blood, optical sensors, pollution), displays (electroluminescent displays (EL), liquid crystal displays (LCD), plasma display panels (PDP), super twisted nematic (STN) displays, thin film transistors (TFT)), nanotechnology, NLO (nonlinear optical films), photonics, plastics, photography (erasable image forming material for electrophotography), chromatography, auto (fluid indicator), general use (mugs/cups, candles), military purposes (temporary mine markers) and pH indicators.

The term “herbicide” includes any agent which destroys and/or inhibits the growth of undesirable plants and can be used in a preplanting, preemergence, postemergence or sterilant application. Suitable herbicides include, for example, Chlorpropham, Propham, Oxyfluorfen, Endothall, Roundup.RTM., and the like

The term “insecticide” includes any agent used primarily for the control of insects by preventing, destroying, repelling or mitigating any insects which may be present in any environment whatsoever. Exemplary of suitable insecticides and acaracides are bromopropylate, cypermethrin, dichlorphos, isazofos, methidathion, profenofos, diazinon, and furathiocarb and diafenthiuron.

The term “fungicide” includes any agent used primarily for the control of a fungus by preventing, destroying, repelling or mitigating any fungus. Exemplary of suitable fungicides are metalaxyl, pyroquilon, penconazol, fenpiclonil, propiconazol, 2-phenylamino-4-methyl-6-cyclopropylpyrimidine and difenconazol.

The term “liquid plant food” is known in the art and is intended to encompass aqueous based solutions that include nutrients, vitamins, minerals, and the like that are useful in supporting the growth of vegetation. One of example of a suitable liquid plant food is Miracle-Gro LiquidFeed, by Scott Miracle Gro.

The terms “dog spray” and “cat spray” are intended to include various materials that can be applied to a dog or cat by an aerosol. The aerosol can contain agents that can kill ticks, fleas, overcome dry skin, etc.

The term “fabric refreshener” is known in the art and is intended to encompass those products that are used with articles of clothing that have an undesirable odor from smoke, sweat and the like and when applied, eliminate that odor. A suitable example of a fabric refreshener is known as “Fabreze Fabric” refresher.

The term “liquid bandage” is known in the art and intended to include those materials that are applied to a cut, scrap, etc. on a person as a liquid, that then undergoes a physical change so that a protecting coating covers the injury. Suitable examples include Nexcare spray liquid bandage by 3M and Johnson & Johnson's Liquid Band-aid material, referred to as Dermabond.

The term “stain remover” is known in the art and is intended to include those materials that are applied to an article, such as clothing, rug, and the like that are soiled with a foreign material. Suitable stain removers include Spray N Wash Laundry Stain remover by Reckitt Benckiser.

These, as well as other application noted throughout the specification can be combined with at least one of the acid-base indicators contained herein. The combination can then be applied to a desired substrate so that the initial application can be readily visualized and then, with some action (evaporation, friction, etc.), the color disappears at the site of application. This is very useful in terms of identifying where an individual wishes to apply the substance and then doesn't wish to later note the point of application

Emulsifiers

Emulsifiers (i.e., emulsifying agents) are also used in certain aspects of the invention in amounts effective to provide uniform blending of ingredients of the composition. Useful emulsifiers include (i) anionics such as fatty acid soaps, e.g., potassium stearate, sodium stearate, ammonium stearate, and triethanoiamine stearate; polyol fatty acid monoesters containing fatty acid soaps, e.g., glycerol monostearate containing either potassium or sodium salt; sulfuric esters (sodium salts), e.g., sodium lauryl 5 sulfate, and sodium cetyl sulfate; and polyol fatty add monoesters containing sulfuric esters, e.g., glyceryl monostearate containing sodium lauryl sulfate; (ii) cationics chloride such as N(stearoyl colamino formylmethyl) pyridium; N-soya-N-ethyl morpholinium ethosulfate; alkyl dimethyl benzyl ammonium chloride; diisobutylphenoxytheoxyethyl dimethyl benzyl ammonium chloride; and cetyl pyridium chloride; and (iii) nonionics such as polyoxyethylene fatty alcohol ethers, e.g., monostearate; polyoxyethylene lauryl alcohol; polyoxypropylene fatty alcohol ethers, e.g., propoxylated oleyl alcohol; polyoxyethylene fatty acid esters, e.g., polyoxyethylene stearate; polyoxyethylene sorbitan fatty acid esters, e.g., polyoxyethylene sorbitan monostearate; sorbitan fatty acid esters, e.g., sorbitan; polyoxyethylene glycol fatty acid esters, e.g., polyoxyethylene glycol monostearate; and polyol fatty acid esters, e.g., glyceryl monostearate and propylene glycol monostearate; and ethoxylated lanolin derivatives, e.g., ethoxylated lanolins, ethoxylated lanolin alcohols and ethoxylated cholesterol.

Surfactants

Surfactants are also used in certain compositions of the invention. Suitable surfactants may include, for example, those surfactants generally grouped as cleansing agents, emulsifying agents, foam boosters, hydrotropes, solubilizing agents, suspending agents and nonsurfactants (facilitates the dispersion of solids in liquids).

The surfactants are usually classified as amphoteric, anionic, cationic and nonionic surfactants. Amphoteric surfactants include acylamino acids and derivatives and N-alkylamino acids. Anionic surfactants include: acylamino acids and salts, such as, acylglutamates, acylpeptides, acylsarcosinates, and acyltaurates; carboxylic acids and salts, such as, alkanoic adds, ester carboxylic adds, and ether carboxylic acids; sulfonic acids and salts, such as, acyl isethionates, alkylaryl sulfonates, alkyl sulfonates, and sulfosuccinates; sulfuric acid esters, such as, alkyl ether sulfates and alkyl sulfates. Cationic surfactants include: alkylamines, alkyl imidazolines, ethoxylated amines, and quaternaries (such as, alkylbenzyldimethylammonium salts, alkyl betaines, heterocyclic ammonium salts, and tetra alkylammonium salts). And nonionic surfactants include: alcohols, such as primary alcohols containing 8 to 18 carbon atoms; alkanolamides such as alkanolamine derived amides and ethoxylated amides; amine oxides; esters such as ethoxylated carboxylic acids, ethoxylated glycerides, glycol esters and derivatives, monoglycerides, polyglyceryl. esters, polyhydric alcohol esters and ethers, sorbitan/sorbitol esters, and triesters of phosphoric acid; and ethers such as ethoxylated alcohols, ethoxylated lanolin, ethoxylated polysiloxanes, and propoxylated polyoxyethylene ethers.

Waxes

Suitable waxes which are useful in accord with the invention include: animal waxes, such as beeswax, spermaceti, or wool wax (lanolin); plant waxes, such as carnauba or candelilla; mineral waxes, such as montan wax or ozokerite; and petroleum waxes, such as paraffin wax and microcrystalline wax (a high molecular weight petroleum wax). Animal, plant, and some mineral waxes are primarily esters of a high molecular weight fatty alcohol with a high molecular weight fatty acid. For example, the hexadecanoic acid ester of tricontanol is commonly reported to be a major component of beeswax.

Other suitable waxes according to the invention include the synthetic waxes including polyethylene polyoxyethylene and hydrocarbon waxes derived from carbon monoxide and hydrogen.

Representative waxes also include: ceresin; cetyl esters; hydrogenated joioba oil; hydrogenated jojoba wax; hydrogenated rice bran wax; Japan wax; jojoba butter; jojoba oil; jojoba wax; munk wax; montan acid wax; ouricury wax; rice bran wax; shellac wax; sufurized jojoba oil; synthetic beeswax; synthetic jojoba oils; trihydroxystearin; cetyl alcohol; stearyl alcohol; cocoa butter; fatty acids of lanolin; mono-, di- and 25 triglycerides which are solid at 25.degree. C., e.g., glyceyl tribehenate (a triester of behenic acid and glycerine) and C1g-C36 acid triglyceride (a mixture of triesters of C1g-C36 carboxylic acids and glycerine) available from Croda, Inc., New York, N.Y. under the tradenames Syncrowax HRC and Syncrowax HGL-C, respectively; fatty esters which are solid at 25.degree. C.; silicone waxes such as methyloctadecaneoxypolysiloxane and poly (dimethylsiloxy) stearoxysiloxane; stearyl mono- and diethanolamide; rosin and its derivatives such as the abietates of glycol and glycerol; hydrogenated oils solid at 25.degree. C.; and sucroglycerides. Thickeners (viscosity control agents) which may be used in effective amounts in aqueous systems include: algin; carbomers such as carbomer 934, 934P, 940 and 941; cellulose gum; cetearyl alcohol, cocamide DEA, dsxtrin; gelatin; hydroxyethylcellulose; hydroxypropylcellulose; hydroxypropyl methylcellulose; magnesium aluminum silicate; myristyl alcohol; oat flour; oleamide DEA; oleyl alcohol; PEG-7M; PEG-14M; PEG-90M; stearamide DEA; Stearamide MEA; stearyl alcohol; tragacanth gum; wheat starch; xanthan gum; and the like in the above list of thickeners, DEA is diethanolamine, and MEA is monoethanolamine. Thickeners (viscosity control agents) which may be used in effective amounts in nonaqueous systems include, aluminum stearates; beeswax; candelilla wax; carnauba; ceresin; cetearyl alcohol; cetyl alcohol; cholesterol; hydrated silica; hydrogenated castor oil; hydrogenated cottonseed oil; hydrogenated soybean oil; hydrogenated tallow glyceride; hydrogenated vegetable oil; hydroxypropyl cellulose; lanolin alcohol; myristyl alcohol; octytdodecyl stearoyl sulfate; oleyl alcohol; ozokerite; microcystalline wax; paraffin; pentaerythrityl tetraoctanoate; polyacrylamide; polybutene; polyethylene; propylene glycol dicaprylate; propylene glycol dipelargonate; stearalkonium hectorite; stearyl alcohol; stearyl stearate; synthetic beeswax; trihydroxystearin; trilinolein; tristearin; zinc stearate; and the like.

Film Formers

Suitable film formers which are used in accord with the invention keep the composition smooth and even and include, without limitation: acrylamide/sodium acrylate copolymer; ammonium acrylates copolymer; Balsam Peru; cellulose gum; ethylene/maleic anhydride copolymer; hydroxyethylcellulose; hydroxypropylcellulose; polyacrylamide; polyethylene; polyvinyl alcohol; pvm/MA copolymer (polyvinyl methylether/maleic anhydride); PVP (polyvinylpyrrolidone); maleic anhydride copolymer such as PA-18 available from Gulf Science and Technology; PVP/hexadecene copolymer such as Ganex V-216 available from GAF Corporation; acryliclacrylate copolymer; and the like.

Generally, film formers can be used in amounts of about 0.1% to about 10% by weight of the total composition with about 1% to about 8% being preferred and about 0.1.degree./O to about 5% being most preferred. Humectants can also be used in effective amounts, including: fructose; glucose; glulamic acid; glycerin; honey; maltitol; methyl gluceth-10; methyl gluceth-20; propylene glycol; sodium lactate; sucrose; and the like.

Preservatives

Preservatives according to certain compositions of the invention include, without limitation: butylparaben; ethylparaben; imidazolidinyl urea; methylparaben; O-phenylphenol; propylparaben; quaternium-14; quaternium-15; sodium dehydroacetate; zinc pyrithione; and the like.

The preservatives are used in amounts effective to prevent or retard microbial growth. Generally, the preservatives are used in amounts of about 0.1% to about 1% by weight of the total composition with about 0.1% to about 0.8% being preferred and about 0.1% to about 0.5% being most preferred.

Perfumes

Perfumes (fragrance components) and colorants (coloring agents) well known to those skilled in the art may be used in effective amounts to impart the desired fragrance and color to the compositions of the invention.

Other ingredients which can be added or used in amounts effective for their intended use, including: biological additives to enhance performance or consumer appeal such as amino adds, proteins, vanilla, aloe extract, bioflavinoids, and the like;: buffering agents, chelating agents such as EDTA; emulsion stabilizers; pH adjusters;. opacifying agents; and propellants such as butane carbon dioxide, ethane, hydrochlorofluorocarbons 22 and 142b, hydrofluorocarbon 152a, isobutane, isopentane, nitrogen, nitrous oxide, pentane, propane, and the like.

The ingredients described above such as emollients, emulsifiers, surfactants, solvents, waxes, thickeners, film formers, humectants, preservatives, surfactants, perfumes, coloring agents, biological additives, buffering agents, chelating agents, emulsion stabilizers, opacifying agents, pH adjusters, and propellants—are well known to those skilled in the art. The. determination of which ingredients to use to obtain the intended formulations, and the determination of the amounts which may be used to achieve the intended functions and effects of these ingredients are well within the capabilities of those skilled in the art without the need for undue experimentation. Further information may be obtained on these ingredients, for example, by reference to: Cosmetics & Toiletries, Vol. 102, No. 3, March 1987; Balsam, M. S., et al., editors, Cosmetics Science and Technology, 2nd edition, Vol. 1, pp 27-104 and 179-222 Wiley-Interscience, New York, 1972; Cosmetics & Toiletries, Vol. 104, pp 67-111, February 1989; Cosmetics & Toiletries, Vol. 103, No. 12, pp 100-129, December 1988; Nikitakis, J. M., editor, CTFA Cosmetic Ingredient Handbrook, First Edition, published by The Cosmetic, Toiletry and Fragrance Association, Inc., Washington, D.C., 1988; Mukhtar, H, editor, Pharmacology of the Skin, CRC Press 1992; and Green; F J, The Sigma-Aldrich Handbook of Stains, Dyes and Indicators., Aldrich Chemical Company, Milwaukee Wis., 1991.

Acid-Base Indicators

Representative examples of acid-base indicators useful in the compositions and articles of the present invention include, but are not limited to, picric acid, matius yellow, 2,6-dinitrophenol, 2,4-dinitrophenol, phenacetolin, 2,5-dinitrophenol, isopicramic acid, o-nitrophenol, m-nitrophenol, p-nitrophenol, 6,8-dinitro-2,4-(1H,3H)quinazolinedione, nitroamine, ethyl bis(2,4-dinitrophenyl)-acetate, 2,4,6-trinitrotoluene, 1,3,5-trinitrobenzene, 2,4,6-tribromobenzoic acid, 2-(p-dimethylaminophenyl)azopyridine, metanil yellow, p-methyl red, 4-phenylazodiphenylamine, benzopurpurin 4B, tropaeolin OO, fast garnet GBC base, alizarin yellow R, benzyl orange, m-methyl red, 4-(m-tolyl)-azo-N,N-dimethyl-aniline, oil yellow II, methyl orange, ethyl orange, hessian purple N, congo red, N-pnehyl-1-naphthyl-aminoazobenzene-p-sulfonic acid, 4-(4′-dimethylamino-1′-naphthyl)-azo-3-methoxy-benzenesulfonic acid, p-ethoxychrysoidine, α-naphthyl red, chrysoidine, 1-naphthylaminoazobenzene-p-sulfonic acid, methyl red, 2-(p-dimethylaminophenyl)-azopyridine, ethyl red, propyl red, N-phenyl-1-naphthyl-aminoazo-o-carboxybenzene, nitrazol yellow, brilliant yellow, brilliant yellow S, orange II, propyl-o-naphthyl orange, orange I, orange IV, hessian, Bordeaux, diazo violet, α-naphthol violet, alizarin yellow GG, chrome orange GR, sulfone acid blue R, lanacyl violet BF, tropaeolin O, orange G, crystal violet, methyl violet B, malachite green, brilliant green, ethyl violet, methyl violet 6B, ethyl/methyl green, basic fuchsine, acid, fuchsine, patent blue V, alkali blue, aniline blue, o-naphthol benzein, pentamethoxy red, hexamethoxy red, tetrabromophenolphthalein ethyl ester K salt, tetraiodophenolsulfophthlein, bromochlorophenol blue, bromocresol green, chlorocresol green, chlorophenol red, bromocresol purple, sulfonaphthyl red, bromophenol red, dibromophenol-tetrabromophenol-sulfophthlein, bromothymol blue, aurin, phenol red, o-cresol benzein, o-cresol red, α-naphtholphthlein, m-cresol purple, p-xylenol blue, thymol blue, phenoltetrachlorophthlein, o-cresolphthalein, α-naphtholbenzein, phenoltetraiodophthlein, phenolphthalein, thymolphthlein, eosin Y, erythrosine B, erythrosine, galleon, brilliant cresyl blue, resazurin, lacmoid, litmus, azolitmus, azolitmin, neutral red, nile blue 2B, nile blue A, hematoxylin, quinaldine red, pinachrome, indo-oxine, quinoline blue, bis-5-bromovanillidenecyclohexanone, bis-(2′-hydroxystyryl)ketone, curcumin, bis-(4-hydroxy-3-ethoxy-benzylidene)-cyclohexanone, thiazole yellow G, alizarin blue B, alizarin red S, carminic acid, alizarin orange, alizarin, rufianic acid, rufianic blue, alizarin blue SWR, and indigo carmine.

With the suitable selection of acid-base indicators, it is possible to produce any color. The acid-base indicators are preferably in the form of a salt, such as a sodium salt generated by reacting the indicator with sodium hydroxide, so as to permit its solubilization into the present composition. Additionally, combinations of two or more indicators may be used.

Acid-base indicators are usually effective when present in small amounts in the compositions of the invention but generally are present in amounts from about 0.01% up to about 20% by weight, from about 0.5% to about 10% by weight and from about 0.8% to about 8% by weight of the total weight of the composition.

Selection of an appropriate basic material is important for color change of acidic dye indicators in the colored compositions of the present invention. Desirable basic reagents, which should readily volatilize at ambient temperatures for use in the present compositions, include, but are not limited to, aminoalcohols, such as alkylamines, such as methylamine, dimethylamine, ethylamine, diethylamine, triethylamine, ethyleneamine, diethyleneamine, morpholine, ammonia, triethanolamine.

The selection of the kind and the amount of basic reagent used enables control of fading time of the color after application. Suitable basic reagents which readily volatilize at ambient temperatures, typically have a vapor pressure higher than about 10 mm Hg at 20° C. The selection of the base also depends on solubility in water, toxicity and odor. Therefore, aminoalcohols useful in the compositions of the present invention include, but are not limited to triethanolamine (TEA) and/or diethylamine. TEA, for example, is clear, non-toxic and does not emit a noxious odor.

The basic reagent(s) is generally present in the composition of the invention in an amount from about 0.01% up to about 20% by weight, from about 0.2% to about 10% by weight and from about 0.5% to about 5% by weight.

It should be understood that the term “comprising” (or comprises) includes the more restrictive terms consisting of and consisting essentially of.

Particular phthaleins useful in the invention have the formula (I):

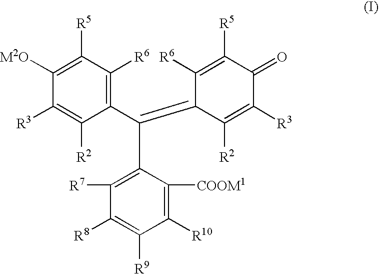

wherein R², R³, R⁵, R⁶, R⁷, R⁸, R⁹ and R¹⁰ are each, independently of one another, selected from the group consisting of hydrogen, —OH, —SH, —CN, —NO₂ halo, fluoro, chloro, bromo, iodo, lower alkyl, substituted lower alkyl, lower heteroalkyl, substituted lower heteroalkyl, cycloalkyl, substituted cycloalkyl, cycloheteroalkyl, substituted cycloheteroalkyl, lower haloalkyl, monohalomethyl, dihalomethyl, trihalomethyl, trifluoromethyl, lower alkylthio, substituted lower alkylthio, lower alkoxy, substituted lower alkoxy, methoxy, substituted methoxy, lower heteroalkoxy, substituted lower heteroalkoxy, cycloalkoxy, substituted cycloalkoxy, cycloheteroalkoxy, substituted cycloheteroalkoxy, lower haloalkoxy, monohalomethoxy, dihalomethoxy, trihalomethoxy, trifluoromethoxy, amino, lower di- or monoalkylamino, substituted lower di- or monoalkylamino, aryl, substituted aryl, aryloxy, substituted aryloxy, phenoxy, substituted phenoxy, arylalkyl, substituted arylalkyl, arylalkyloxy, substituted arylalkyloxy, benzyl, benzyloxy, heteroaryl, substituted heteroaryl, heteroaryloxy, substituted heteroaryloxy, heteroarylalkyl, substituted heteroarylalkyl, heteroarylalkyloxy, substituted heteroarylalkyloxy, carboxyl, lower alkoxycarbonyl, substituted lower alkoxycarbonyl, aryloxycarbonyl, substituted aryloxycarbonyl, arylalkyloxycarbonyl, substituted arylalkyloxycarbonyl, carbamate, substituted carbamate, carbamoyl, substituted carbamoyl, sulfamoyl or substituted sulfamoyl.

Alternatively, R² and R³, R⁵ and R⁶ or R² and R³, and R⁵ and R⁶ can form cyclic ring structures that are heterocyclic, heteroaromatic, aromatic or nonaromatic and can contain one or more heteroatoms to form, for example, a quinoline, napthalene, etc.

Additionally, R⁷ and R⁸, R⁸ and R⁹, R⁹ and R¹⁰ or combinations thereof can form cyclic ring structures that are heterocyclic, heteroaromatic, aromatic or nonaromatic and can contain one or more heteroatoms to form, for example, a quinoline, napthalene, etc.

Optionally, one of the carbons connected to R², R³, R⁵ or R⁶ can be substituted with a nitrogen atom.

M¹ and M² are each independently a hydrogen atom, a metal ion or an ammonium ion.

In certain aspects, compounds are excluded where R², R³, R⁵, R⁶, R⁷, R⁸, R⁹ and R¹⁰ are all hydrogen atoms, or where R² is hydrogen, R³ is Me, and R⁵, R⁶, R⁷, R⁸, R⁹ and R¹⁰ are all hydrogen atoms, or where R² is Me, R³is a hydrogen atom, R⁵ is an iso-propyl group and R⁶, R⁷, R⁸, R⁹ and R¹⁰ are all hydrogen atoms.

In certain embodiments, R² is selected from the group consisting of hydrogen, nitro, amino and alkyl; R³ is selected from the group consisting of hydrogen, phenyl, alkyl, nitro, acetamido and alkoxy; R⁵ is selected from the group consisting of hydrogen, halo, and alkyl; and R⁶ is selected from the group consisting of hydrogen and alkyl.

In certain other embodiments, R² is selected from the group consisting of hydrogen and methyl; R³is selected from the group consisting of hydrogen, phenyl, isopropyl, methyl, ethyl, sec-butyl, nitro and methoxy; R⁵ is selected from the group consisting of hydrogen, bromo, methoxy, isopropyl and methyl; and R⁶ is selected from the group consisting of hydrogen and methyl.

In other embodiments, R², R³, R⁵, R⁶, R⁷, R⁸, R⁹ and R¹⁰ are all hydrogen atoms, or R² is hydrogen, R³ is Me, and R⁵, R⁶, R⁷, R⁸, R⁹ and R¹⁰ are all hydrogen atoms, or R² is Me, R³ is a hydrogen atom, R⁵ is an iso-propyl group and R⁶, R⁷, R⁸, R⁹ and R¹⁰ are all hydrogen atoms, or R² is H, R³ is Me, R⁵ is Br and R⁶, R⁷, R⁸, R⁹ and R¹⁰ are all hydrogen atoms, or R² is Me, R³ is Br, R⁵ is an isopropyl and R⁶, R⁷, R⁸, R⁹ and R¹⁰ are all hydrogen atoms. In certain embodiments, one or more of these compounds may be excluded from certain aspects of the invention.

In still other embodiments, R² is H, R³ is phenyl and R⁵, R⁶, R⁷, R⁸, R⁹ and R¹⁰ are all hydrogen atoms, or R² is H, R³ and R⁵ are isopropyl and R⁶, R⁷, R⁸, R⁹ and R¹⁰ are all hydrogen atoms, or R² is H, R³ is methyl, R⁵ is H, R⁶ is methyl, R⁷, R⁸, R⁹ and R¹⁰ are all hydrogen atoms, or R² is H, R³ and R⁵ are methoxy and R⁶, R⁷, R⁸, R⁹ and R¹⁰ are all hydrogen atoms, or R² is H, R³ and R⁵ are methyl and R⁶, R⁷, R⁸, R⁹ and R¹⁰ are all hydrogen atoms, or R² is H, R³ is ethyl and R⁵, R⁶, R⁷, R⁸, R⁹ and R¹⁰ are all hydrogen atoms, or R² is H, R³ is isopropyl and R⁵, R⁶, R⁷, R⁸, R⁹ and R¹⁰ are all hydrogen atoms, or R² is H, R³ is methoxide and R⁵, R⁶, R⁷, R⁸, R⁹ and R¹⁰ are all hydrogen atoms, or and R², R³ and R⁵ are all methyl and R⁶, R⁷, R⁸, R⁹ and R¹⁰ are all hydrogen atoms, or R², R³, R⁵, R⁶, R⁷, R⁸, R⁹, R¹⁰ are all hydrogen atoms and R³ is sec-butyl, or R², R³, R⁵, R⁶, R⁷, R⁸, R⁹, R¹⁰ are all hydrogen atoms and R³ is nitro.

In particular, at least one of M¹ or M² is a metal or an ammonium ion.

It should be understood, that the salt form of the indicator can be isolated prior to use or prepared in situ. Ideally, the salt is formed as a mono-salt or a di-salt, meaning that excess base is not present and either 1 or 2 equivalents of base react with the acidic protons of the indicator.

In another particular aspect, especially where a color change from clear to colored is desired, then M¹ and M² are hydrogen atoms.

The following table provides phthaleins of particular interest.

| R² | R³ | R⁵ | R⁶ | Color |
|---|---|---|---|---|
| H | phenyl | H | H | purple |
| H | i-propyl | i-propyl | H | violet |
| H | Me | H | Me | blue |
| H | OMe | OMe | H | teal |
| H | Me | Me | H | purple |
| H | Et | H | H | magenta |
| H | i-propyl | H | H | pink |
| H | OMe | H | H | blue |
| Me | Me | Me | H | teal |
| H | Me | H | H | magenta |
| H | i-propyl | H | Me | blue |
| H | Me | Br | H | purple |
| H | i-propyl | Br | Me | teal |
| H | sec-butyl | H | H | pink |
| H | NO₂ | H | H | yellow |

In another aspect, the acid-base indicator can be a substituted phenol of formula (II):

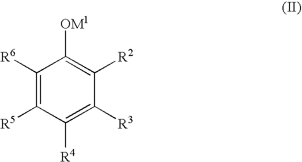

wherein R², R³, R⁵, R⁶ and M¹ are as defined above and R⁴ is selected from the same group as R², R³, R⁵ and R⁶.

Alternatively, R² and R³, R³ and R⁴, R⁴ and R⁵, or R⁵ and R⁶ can form cyclic ring structures that are heterocyclic, heteroaromatic, aromatic or nonaromatic and can contain one or more heteroatoms to form, for example, a quinoline, napthalene, etc.

In one aspect, one or more of R² through R⁶, independently, is a nitro (—NO₂) group and the remaining R groups are selected from those provided above.

Additionally, substituted hydrazides are useful in the compositions of the invention and can have one of two formulae:

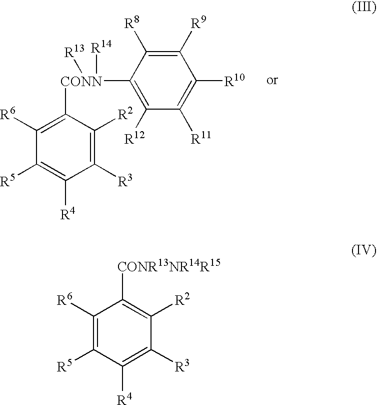

wherein R² through R⁶ are as defined above and R⁸ through R¹² are the same substituents as R² through R⁶. R¹³, R¹⁴ and R¹⁵ (if present) are each, independently of one another, a hydrogen atom, an alkyl group, a substituted alkyl group, any aryl group or a substituted aryl group.

In certain embodiments for compound formulae (II), R¹³ and R¹⁴ are hydrogen atoms and for compound formulae (III), R¹³, R¹⁴ and R¹⁵ are all hydrogen atoms.

In certain aspects, compounds of formulae (III) can have one or more hydroxyl groups, which can be deprotonated to form a salt. For example, formulae (IIIa) provides one isomer where a hydroxyl is present at the R² position as a salt. M² is as defined above for M¹. It should be understood that one or more of R² through R¹² could have a hydroxyl at that given position, and that hydroxyl could be in a salt form.

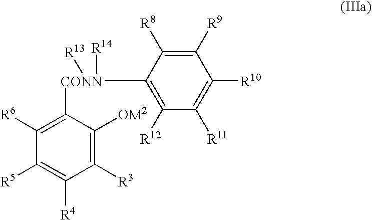

“Alkyl,” by itself or as part of another substituent, refers to a saturated or unsaturated, branched, straight-chain or cyclic monovalent hydrocarbon radical derived by the removal of one hydrogen atom from a single carbon atom of a parent alkane, alkene or alkyne. Typical alkyl groups include, but are not limited to, methyl; ethyls such as ethanyl, ethenyl, ethynyl; propyls such as propan-1-yl, propan-2-yl, cyclopropan-1-yl, prop-1-en-1-yl, prop-1-en-2-yl, prop-2-en-1-yl (allyl), cycloprop-1-en-1-yl; cycloprop-2-en-1-yl, prop-1-yn-1-yl , prop-2-yn-1-yl, etc.; butyls such as butan-1-yl, butan-2-yl, 2-methyl-propan-1-yl, 2-methyl-propan-2-yl, cyclobutan-1-yl, but- 1-en-1-yl, but-1-en-2-yl, 2-methyl-prop-1-en-1-yl, but-2-en-1-yl , but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, but-1-yn-1-yl, but-1-yn-3-yl, but-3-yn-1-yl, etc.; and the like.

The term “alkyl” is specifically intended to include groups having any degree or level of saturation, i.e., groups having exclusively single carbon-carbon bonds, groups having one or more double carbon-carbon bonds, groups having one or more triple carbon-carbon bonds and groups having mixtures of single, double and triple carbon-carbon bonds. Where a specific level of saturation is intended, the expressions “alkanyl,” “alkenyl,” and “alkynyl” are used. Preferably, an alkyl group comprises from 1 to 15 carbon atoms (C₁-C₁₅ alkyl), more preferably from 1 to 10 carbon atoms (C₁-C₁₀ alkyl) and even more preferably from 1 to 6 carbon atoms (C₁-C₆ alkyl or lower alkyl).

“Alkanyl,” by itself or as part of another substituent, refers to a saturated branched, straight-chain or cyclic alkyl radical derived by the removal of one hydrogen atom from a single carbon atom of a parent alkane. Typical alkanyl groups include, but are not limited to, methanyl; ethanyl; propanyls such as propan-1-yl, propan-2-yl (isopropyl), cyclopropan-1-yl, etc.; butanyls such as butan-1-yl, butan-2-yl (sec-butyl), 2-methyl-propan-1-yl (isobutyl), 2-methyl-propan-2-yl (t-butyl), cyclobutan-1-yl, etc.; and the like.

“Alkenyl,” by itself or as part of another substituent, refers to an unsaturated branched, straight-chain or cyclic alkyl radical having at least one carbon-carbon double bond derived by the removal of one hydrogen atom from a single carbon atom of a parent alkene. The group may be in either the cis or trans conformation about the double bond(s). Typical alkenyl groups include, but are not limited to, ethenyl; propenyls such as prop-1-en-1-yl , prop-1-en-2-yl, prop-2-en-1-yl (allyl), prop-2-en-2-yl, cycloprop-1-en-1-yl; cycloprop-2-en-1-yl; butenyls such as but-1-en-1-yl, but-1-en-2-yl, 2-methyl-prop-1-en-1-yl, but-2-en-1-yl , but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, etc.; and the like.

“Alkynyl,” by itself or as part of another substituent refers to an unsaturated branched, straight-chain or cyclic alkyl radical having at least one carbon-carbon triple bond derived by the removal of one hydrogen atom from a single carbon atom of a parent alkyne. Typical alkynyl groups include, but are not limited to, ethynyl; propynyls such as prop-1-yn-1-yl, prop-2-yn-1-yl, etc.; butynyls such as but-1-yn-1-yl, but-1-yn-3-yl, but-3-yn-1-yl, etc.; and the like.

“Alkyldiyl” by itself or as part of another substituent refers to a saturated or unsaturated, branched, straight-chain or cyclic divalent hydrocarbon group derived by the removal of one hydrogen atom from each of two different carbon atoms of a parent alkane, alkene or alkyne, or by the removal of two hydrogen atoms from a single carbon atom of a parent alkane, alkene or alkyne. The two monovalent radical centers or each valency of the divalent radical center can form bonds with the same or different atoms. Typical alkyldiyl groups include, but are not limited to, methandiyl; ethyldiyls such as ethan-1,1-diyl, ethan-1,2-diyl, ethen-1,1-diyl, ethen-1,2-diyl; propyldiyls such as propan-1,1-diyl, propan-1,2-diyl, propan-2,2-diyl, propan-1,3-diyl, cyclopropan-1,1-diyl, cyclopropan-1,2-diyl, prop-1-en-1,1-diyl, prop-1-en-1,2-diyl, prop-2-en-1,2-diyl, prop-1-en-1,3-diyl, cycloprop-1-en-1,2-diyl, cycloprop-2-en-1,2-diyl, cycloprop-2-en-1,1-diyl, prop-1-yn-1,3-diyl, etc.; butyldiyls such as, butan-1,1-diyl, butan-1,2-diyl, butan-1,3-diyl, butan-1,4-diyl, butan-2,2-diyl, 2-methyl-propan-1,1-diyl, 2-methyl-propan-1,2-diyl, cyclobutan-1,1-diyl; cyclobutan-1,2-diyl, cyclobutan-1,3-diyl, but-1-en-1,1-diyl, but-1-en-1,2-diyl, but-1-en-1,3-diyl, but-1-en-1,4-diyl, 2-methyl-prop-1-en-1,1 -diyl, 2-methanylidene-propan-1,1-diyl, buta-1,3-dien-1,1-diyl, buta-1,3-dien-1,2-diyl, buta-1,3-dien-1,3-diyl, buta-1,3-dien-1,4-diyl, cyclobut-1-en-1,2-diyl, cyclobut-1-en-1,3-diyl, cyclobut-2-en-1,2-diyl, cyclobuta-1,3-dien-1,2-diyl, cyclobuta-1,3-dien-1,3-diyl, but-1-yn-1,3 -diyl, but-1-yn-1,4-diyl, buta-1,3-diyn-1,4-diyl, etc.; and the like. Where specific levels of saturation are intended, the nomenclature alkanyldiyl, alkenyldiyl and/or alkynyldiyl is used. Where it is specifically intended that the two valencies are on the same carbon atom, the nomenclature “alkylidene” is used. In preferred embodiments, the alkyldiyl group comprises from 1 to 6 carbon atoms (C1-C6 alkyldiyl). Also preferred are saturated acyclic alkanyldiyl groups in which the radical centers are at the terminal carbons, e.g., methandiyl (methano); ethan-1,2-diyl (ethano); propan-1,3-diyl (propano); butan-1,4-diyl (butano); and the like (also referred to as alkylenos, defined infra).

“Alkyleno,” by itself or as part of another substituent, refers to a straight-chain saturated or unsaturated alkyldiyl group having two terminal monovalent radical centers derived by the removal of one hydrogen atom from each of the two terminal carbon atoms of straight-chain parent alkane, alkene or alkyne. The locant of a double bond or triple bond, if present, in a particular alkyleno is indicated in square brackets. Typical alkyleno groups include, but are not limited to, methano; ethylenos such as ethano, etheno, ethyno; propylenos such as propano, prop[1,2]eno, propa[1,2]dieno, prop[1]yno, etc.; butylenos such as butano, but[1]eno, but[2]eno, buta[1,3]dieno, but[1]yno, but[2]yno, buta[1,3]diyno, etc.; and the like. Where specific levels of saturation are intended, the nomenclature alkano, alkeno and/or alkyno is used. In preferred embodiments, the alkyleno group is (C1-C6) or (C1-C3) alkyleno. Also preferred are straight-chain saturated alkano groups, e.g., methano, ethano, propano, butano, and the like.

“Alkoxy,” by itself or as part of another substituent, refers to a radical of the formula —OR, where R is an alkyl or cycloalkyl group as defined herein. Representative examples alkoxy groups include, but are not limited to, methoxy, ethoxy, propoxy, isopropoxy, butoxy, tert-butoxy, cyclopropyloxy, cyclopentyloxy, cyclohexyloxy and the like.

“Alkoxycarbonyl,” by itself or as part of another substituent, refers to a radical of the formula —C(O)-alkoxy, where alkoxy is as defined herein.

“Alkylthio,” by itself or as part of another substituent, refers to a radical of the formula —SR, where R is an alkyl or cycloalkyl group as defined herein. Representative examples of Alkylthio groups include, but are not limited to, methylthio, ethylthio, propylthio, isopropylthio, butylthio tert-butylthio, cyclopropylthio, cyclopentylthio, cyclohexylthio, and the like.

“Aryl,” by itself or as part of another substituent, refers to a monovalent aromatic hydrocarbon group derived by the removal of one hydrogen atom from a single carbon atom of a parent aromatic ring system, as defined herein. Typical aryl groups include, but are not limited to, groups derived from aceanthrylene, acenaphthylene, acephenanthrylene, anthracene, azulene, benzene, chrysene, coronene, fluoranthene, fluorene, hexacene, hexaphene, hexalene, αs-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene and the like. Preferably, an aryl group comprises from 6 to 20 carbon atoms (C₆-C₂₀ aryl), more preferably from 6 to 15 carbon atoms (C₆-C₁₅ aryl) and even more preferably from 6 to 10 carbon atoms (C₆-C₁₀ aryl).

“Arylalkyl,” by itself or as part of another substituent, refers to an acyclic alkyl group in which one of the hydrogen atoms bonded to a carbon atom, typically a terminal or sp³ carbon atom, is replaced with an aryl group as, as defined herein. Typical arylalkyl groups include, but are not limited to, benzyl, 2-phenylethan-1-yl, 2-phenylethen-1-yl, naphthylmethyl, 2-naphthylethan-1-yl, 2-naphthylethen-1-yl, naphthobenzyl, 2-naphthophenylethan-1-yl and the like. Where specific alkyl moieties are intended, the nomenclature arylalkanyl, arylalkenyl and/or arylalkynyl is used. Preferably, an arylalkyl group is (C₆-C₃₀) arylalkyl, e.g., the alkanyl, alkenyl or alkynyl moiety of the arylalkyl group is (C₁-C₁₀) alkyl and the aryl moiety is (C₆-C₂₀) aryl, more preferably, an arylalkyl group is (C₆-C₂₀) arylalkyl, e.g., the alkanyl, alkenyl or alkynyl moiety of the arylalkyl group is (C₁-C₈) alkyl and the aryl moiety is (C₆-C₁₂) aryl, and even more preferably, an arylalkyl group is (C₆-C₁₅) arylalkyl, e.g., the alkanyl, alkenyl or alkynyl moiety of the arylalkyl group is (C₁-C₅) alkyl and the aryl moiety is (C₆-C₁₀) aryl.

“Aryloxy,” by itself or as part of another substituent, refers to a radical of the formula —O-aryl, where aryl is as defined herein.

“Arylalkyloxy, by itself or as part of another substituent, refers to a radical of the formula —O-arylalkyl, where arylalkyl is as defined herein.

“Aryloxycarbonyl,” by itself or as part of another substituent, refers to a radical of the formula —C(O)—O-aryl, where aryl is as defined herein.

“Carbamoyl,” by itself or as part of another substituent, refers to a radical of the formula —C(O)NR′R″, where R′ and R″ are each, independently of one another, selected from the group consisting of hydrogen, alkyl and cycloalkyl as defined herein, or alternatively, R′ and R″, taken together with the nitrogen atom to which they are bonded, form a 5-, 6- or 7-membered cycloheteroalkyl ring as defined herein, which may optionally include from 1 to 4 of the same or different additional heteroatoms selected from the group consisting of O, S and N.

“Compounds of the invention” refers to compounds encompassed by the various descriptions and structural formulae disclosed herein. The compounds of the invention may be identified by either their chemical structure and/or chemical name. When the chemical structure and chemical name conflict, the chemical structure is determinative of the identity of the compound. The compounds of the invention may contain one or more chiral centers and/or double bonds and therefore may exist as stereoisomers, such as double-bond isomers (i.e., geometric isomers), rotamers, enantiomers or diastereomers. Accordingly, when stereochemistry at chiral centers is not specified, the chemical structures depicted herein encompass all possible configurations at those chiral centers including the stereoisomerically pure form (e.g., geometrically pure, enantiomerically pure or diastereomerically pure) and enantiomeric and stereoisomeric mixtures. Enantiomeric and stereoisomeric mixtures can be resolved into their component enantiomers or stereoisomers using separation techniques or chiral synthesis techniques well known to the skilled artisan. The compounds of the invention may also exist in several tautomeric forms including the enol form, the keto form and mixtures thereof. Accordingly, the chemical structures depicted herein encompass all possible tautomeric forms of the illustrated compounds. The compounds of the invention may also include isotopically labeled compounds where one or more atoms have an atomic mass different from the atomic mass conventionally found in nature. Examples of isotopes that may be incorporated into the compounds of the invention include, but are not limited to, ²H, ³H, ¹¹C, ¹³C, ¹⁴C, ¹⁵N, ¹⁸O, ¹⁷O, ³¹P, ³²P, ³⁵S, ¹⁸F and ³⁶Cl. Compounds of the invention may exist in unsolvated forms as well as solvated forms, including hydrated forms and as N-oxides. In general, the hydrated, solvated and N-oxide forms are within the scope of the present invention. Certain compounds of the present invention may exist in multiple crystalline or amorphous forms. In general, all physical forms are equivalent for the uses contemplated by the present invention and are intended to be within the scope of the present invention.

“Cycloalkyl,” by itself or as part of another substituent, refers to a saturated or unsaturated cyclic alkyl radical, as defined herein. Where a specific level of saturation is intended, the nomenclature “cycloalkanyl” or “cycloalkenyl” is used. Typical cycloalkyl groups include, but are not limited to, groups derived from cyclopropane, cyclobutane, cyclopentane, cyclohexane, and the like. Preferably, the cycloalkyl group comprises from 3 to 10 ring atoms (C₃-C₁₀ cycloalkyl) and more preferably from 3 to 7 ring atoms (C₃-C₇ cycloalkyl).

“Cycloheteroalkyl,” by itself or as part of another substituent, refers to a saturated or unsaturated cyclic alkyl radical in which one or more carbon atoms (and optionally any associated hydrogen atoms) are independently replaced with the same or different heteroatom. Typical heteroatoms to replace the carbon atom(s) include, but are not limited to, N, P, O, S, Si, etc. Where a specific level of saturation is intended, the nomenclature “cycloheteroalkanyl” or “cycloheteroalkenyl” is used. Typical cycloheteroalkyl groups include, but are not limited to, groups derived from epoxides, azirines, thiiranes, imidazolidine, morpholine, piperazine, piperidine, pyrazolidine, pyrrolidone, quinuclidine, and the like. Preferably, the cycloheteroalkyl group comprises from 3 to 10 ring atoms (3-10 membered cycloheteroalkyl) and more preferably from 5 to 7 ring atoms (5-7 membered cycloheteroalkyl).

A cycloheteroalkyl group may be substituted at a heteroatom, for example, a nitrogen atom, with a lower alkyl group. As specific examples, N-methyl-imidazolidinyl, N-methyl-morpholinyl, N-methyl-piperazinyl, N-methyl-piperidinyl, N-methyl-pyrazolidinyl and N-methyl-pyrrolidinyl are included within the definition of “cycloheteroalkyl.” A cycloheteralkyl group may be attached to the remainder of the molecule via a ring carbon atom or a ring heteroatom.

“Dialkylamino” or “Monoalkylamino,” by themselves or as part of other substituents, refer to radicals of the formula —NRR and —NHR, respectively, where each R is independently selected from the group consisting of alkyl and cycloalkyl, as defined herein. Representative examples of dialkylamino groups include, but are not limited to, dimethylamino, methylethylamino, di-(1-methylethyl)amino, (cyclohexyl)(methyl)amino, (cyclohexyl)(ethyl)amino, (cyclohexyl)(propyl)amino and the like. Representative examples of monalkylamino groups include, but are not limited to, methylamino, ethylamino, propylamino, isopropylamino, cyclohexylamino, and the like.

“Halogen” or “Halo,” by themselves or as part of another substituent, refer to a fluoro, chloro, bromo and/or iodo radical.

“Haloalkyl,” by itself or as part of another substituent, refers to an alkyl group as defined herein in which one or more of the hydrogen atoms is replaced with a halo group. The term “haloalkyl” is specifically meant to include monohaloalkyls, dihaloalkyls, trihaloalkyls, etc. up to perhaloalkyls. The halo groups substituting a haloalkyl can be the same, or they can be different. For example, the expression “(C₁-C₂) haloalkyl” includes 1-fluoromethyl, 1-fluoro-2-chloroethyl, difluoromethyl, trifluoromethyl, 1-fluoroethyl, 1,1-difluoroethyl, 1, 2-difluoroethyl, 1,1,1-trifluoroethyl, perfluoroethyl, etc. “Haloalkyloxy,” by itself or as part of another substituent, refers to a group of the formula —O-haloalkyl, where haloalkyl is as defined herein.

“Heteroalkyl,” “Heteroalkanyl,” “Heteroalkenyl,” “Heteroalkynlyl,” “Heteroalkyldiyl” and “Heteroalkyleno,” by themselves or as part of other substituents, refer to alkyl, alkanyl, alkenyl, alkynyl, alkyldiyl and alkyleno groups, respectively, in which one or more of the carbon atoms (and optionally any associated hydrogen atoms), are each, independently of one another, replaced with the same or different heteroatoms or heteroatomic groups. Typical heteroatoms or heteroatomic groups which can replace the carbon atoms include, but are not limited to, O, S, N, Si, —NH—, —S(O)—, —S(O)₂—, —S(O)NH—, —S(O)₂NH— and the like and combinations thereof. The heteroatoms or heteroatomic groups may be placed at any interior position of the alkyl, alkenyl or alkynyl groups. Examples of such heteroalkyl, heteroalkanyl, heteroalkenyl and/or heteroalkynyl groups include —CH₂—CH₂—O—CH₃, —CH₂—CH₂—NH—CH₃, —CH₂—CH₂—N(CH₃)—CH₃, —CH₂—S—CH₂, —CH₃, —CH₂—CH₂—S(O)—CH₃, —CH₂—CH₂—S(O)₂—CH₃, —CH═CH—O—CH₃, —CH₂—CH═N—O—CH₃, and —CH₂—CH₂—O—C═CH. For heteroalkyldiyl and heteroalkyleno groups, the heteratom or heteratomic group can also occupy either or both chain termini. For such groups, no orientation of the group is implied.

“Heteroaryl,” by itself or as part of another substituent, refers to a monovalent heteroaromatic radical derived by the removal of one hydrogen atom from a single atom of a parent heteroaromatic ring systems, as defined herein. Typical heteroaryl groups include, but are not limited to, groups derived from acridine, β-carboline, chromane, chromene, cinnoline, furan, imidazole, indazole, indole, indoline, indolizine, isobenzofuran, isochromene, isoindole, isoindoline, isoquinoline, isothiazole, isoxazole, naphthyridine, oxadiazole, oxazole, perimidine, phenanthridine, phenanthroline, phenazine, phthalazine, pteridine, purine, pyran, pyrazine, pyrazole, pyridazine, pyridine, pyrimidine, pyrrole, pyrrolizine, quinazoline, quinoline, quinolizine, quinoxaline, tetrazole, thiadiazole, thiazole, thiophene, triazole, xanthene, and the like. Preferably, the heteroaryl group comprises from 5 to 20 ring atoms (5-20 membered heteroaryl), more preferably from 5 to 10 ring atoms (5-10 membered heteroaryl). Preferred heteroaryl groups are those derived from furan, thiophene, pyrrole, benzothiophene, benzofuran, benzimidazole, indole, pyridine, pyrazole, quinoline, imidazole, oxazole, isoxazole and pyrazine.

“Heteroarylalkyl” by itself or as part of another substituent refers to an acyclic alkyl group in which one of the hydrogen atoms bonded to a carbon atom, typically a terminal or sp³ carbon atom, is replaced with a heteroaryl group. Where specific alkyl moieties are intended, the nomenclature heteroarylalkanyl, heteroarylakenyl and/or heteroarylalkynyl is used. In preferred embodiments, the heteroarylalkyl group is a 6-21 membered heteroarylalkyl, e.g., the alkanyl, alkenyl or alkynyl moiety of the heteroarylalkyl is (C1-C6) alkyl and the heteroaryl moiety is a 5-15-membered heteroaryl. In particularly preferred embodiments, the heteroarylalkyl is a 6-13 membered heteroarylalkyl, e.g., the alkanyl, alkenyl or alkynyl moiety is (C1-C3) alkyl and the heteroaryl moiety is a 5-10 membered heteroaryl.

“Parent Aromatic Ring System” refers to an unsaturated cyclic or polycyclic ring system having a conjugated π electron system. Specifically included within the definition of “parent aromatic ring system” are fused ring systems in which one or more of the rings are aromatic and one or more of the rings are saturated or unsaturated, such as, for example, fluorene, indane, indene, phenalene, etc. Typical parent aromatic ring systems include, but are not limited to, aceanthrylene, acenaphthylene, acephenanthrylene, anthracene, azulene, benzene, chrysene, coronene, fluoranthene, fluorene, hexacene, hexaphene, hexalene, αs-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene and the like.

“Parent Heteroaromatic Ring System” refers to a parent aromatic ring system in which one or more carbon atoms (and optionally any associated hydrogen atoms) are each independently replaced with the same or different heteroatom. Typical heteroatoms to replace the carbon atoms include, but are not limited to, N, P, O, S, Si, etc. Specifically included within the definition of “parent heteroaromatic ring system” are fused ring systems in which one or more of the rings are aromatic and one or more of the rings are saturated or unsaturated, such as, for example, benzodioxan, benzofuran, chromane, chromene, indole, indoline, xanthene, etc. Typical parent heteroaromatic ring systems include, but are not limited to, arsindole, carbazole, β-carboline, chromane, chromene, cinnoline, furan, imidazole, indazole, indole, indoline, indolizine, isobenzofuran, isochromene, isoindole, isoindoline, isoquinoline, isothiazole, isoxazole, naphthyridine, oxadiazole, oxazole, perimidine, phenanthridine, phenanthroline, phenazine, phthalazine, pteridine, purine, pyran, pyrazine, pyrazole, pyridazine, pyridine, pyrimidine, pyrrole, pyrrolizine, quinazoline, quinoline, quinolizine, quinoxaline, tetrazole, thiadiazole, thiazole, thiophene, triazole, xanthene and the like.

“Metal ion” or “Metal Salt” refers to a salt of a compound of the invention which is made with counterions understood in the art to be generally acceptable for pharmaceutical uses and which possesses the desired pharmacological activity of the parent compound. Such salts include: (1) acid addition salts, formed with inorganic acids such as hydrochloric acid, hydrobromic acid, sulfuric acid, nitric acid, phosphoric acid, and the like; or formed with organic acids such as acetic acid, propionic acid, hexanoic acid, cyclopentanepropionic acid, glycolic acid, pyruvic acid, lactic acid, malonic acid, succinic acid, malic acid, maleic acid, fumaric acid, tartaric acid, citric acid, benzoic acid, 3-(4-hydroxybenzoyl) benzoic acid, cinnamic acid, mandelic acid, methanesulfonic acid, ethanesulfonic acid, 1,2-ethane-disulfonic acid, 2-hydroxyethanesulfonic acid, benzenesulfonic acid, 4-chlorobenzenesulfonic acid, 2-naphthalenesulfonic acid, 4-toluenesulfonic acid, camphorsulfonic acid, 4-methylbicyclo[2.2.2]-oct-2-ene-1-carboxylic acid, glucoheptonic acid, 3-phenylpropionic acid, trimethylacetic acid, tertiary butylacetic acid, lauryl sulfuric acid, gluconic acid, glutamic acid, hydroxynaphthoic acid, salicylic acid, stearic acid, muconic acid and the like; or (2) salts formed when an acidic proton present in the parent compound is replaced by a metal ion, e.g., an alkali metal ion, an alkaline earth ion, or an aluminum ion; or coordinates with an organic base such as ethanolamine, diethanolamine, triethanolamine, N-methylglucamine, morpholine, piperidine, dimethylamine, diethylamine and the like. Also included are salts of amino acids such as arginates and the like, and salts of organic acids like glucurmic or galactunoric acids and the like (see, e.g., Berge et al., 1977, J. Pharm. Sci. 66:1-19).

“Pharmaceutically acceptable vehicle” refers to a diluent, adjuvant, excipient or carrier with which a compound of the invention is administered.

“Substituted,” when used to modify a specified group or radical, means that one or more hydrogen atoms of the specified group or radical are each, independently of one another, replaced with the same or different substituent(s). Substituent groups useful for substituting saturated carbon atoms in the specified group or radical include, but are not limited to —R^{a}, halo, —O⁻, ═O, —OR^{b}, —SR^{b},—S⁻, ═S, —NR^{c}R^{c}, ═NR^{b}, ═N—OR^{b}, trihalomethyl, —CF₃, —CN, —OCN, —SCN, —NO, —NO₂, ═N₂, —N₃, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{c}R^{c}, —NR^{b}C(NR^{b})R^{b} and —NR^{b}C(NR^{b})NR^{c}R^{c}, where R^{a} is selected from the group consisting of alkyl, cycloalkyl, heteroalkyl, cycloheteroalkyl, aryl, arylalkyl, heteroaryl and heteroarylalkyl; each R^{b} is independently hydrogen or R^{a}; and each R^{c} is independently R^{b} or alternatively, the two R^{c}s are taken together with the nitrogen atom to which they are bonded form a 5-, 6- or 7-membered cycloheteroalkyl which may optionally include from 1 to 4 of the same or different additional heteroatoms selected from the group consisting of O, N and S. As specific examples, —NR^{c}R^{c} is meant to include —NH₂, —NH-alkyl, N-pyrrolidinyl and N-morpholinyl.

Similarly, substituent groups useful for substituting unsaturated carbon atoms in the specified group or radical include, but are not limited to, —R^{a}, halo, —O⁻, —OR^{b}, —SR^{b}, —S—, —NR^{c}R^{c}, trihalomethyl, —CF₃, —CN, —OCN, —SCN, —NO, —NO₂, —N₃, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{c}R^{c}, —NR^{b}C(NR^{b})R^{b}, and —NR^{b}C(NR^{b})NR^{c}R^{c}, where R^{a}, R^{b} and R^{c} are as previously defined.

Substituent groups useful for substituting nitrogen atoms in heteroalkyl and cycloheteroalkyl groups include, but are not limited to, —R^{a}, —O⁻, —OR^{b}, —SR^{b}, —S⁻, —NR^{c}R^{c}, trihalomethyl, —CF₃, —CN, —NO, —NO₂, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)OR^{b}, —OC(S)OR^{b}, —NR^{b}C(O)R^{b}, —NR^{b}C(S)R^{b}, —NR^{b}C(O)OR^{b}, —NR^{b}C(S)OR^{b}, —NR^{b}C(O)NR^{c}R^{c}, —NR^{b}C(NR^{b})R^{b} and —NR^{b}C(NR^{b})NR^{c}R^{c}, where R^{a}, R^{b} and R^{c} are as previously defined.

Substituent groups from the above lists useful for substituting other specified groups or atoms will be apparent to those of skill in the art.

The substituents used to substitute a specified group can be further substituted, typically with one or more of the same or different groups selected from the various groups specified above.

“Sulfamoyl,” by itself or as part of another substituent, refers to a radical of the formula —S(O)₂NR′R″, where R′ and R″ are each, independently of one another, selected from the group consisting of hydrogen, alkyl and cycloalkyl as defined herein, or alternatively, R′ and R″, taken together with the nitrogen atom to which they are bonded, form a 5-, 6- or 7-membered cycloheteroalkyl ring as defined herein, which may optionally include from 1 to 4 of the same or different additional heteroatoms selected from the group consisting of O, S and N.

Suitable solvents useful with the acid-base indicators and compositions described throughout the specification include protic solvents including water, alcohols, polyethyleneoxides, and the like and aqueous solutions with one or more surfactants.

Methods of Synthesis

The particular phthaleins described above can be obtained via synthetic methods illustrated below. It should be understood that in R², R³, R⁵, R⁶, R⁷, R⁸, R⁹ and R¹⁰, are as previously defined for structural formula (I).

Starting materials useful for preparing compounds of the invention and intermediates thereof are commercially available or can be prepared by well-known synthetic methods (see, e.g., Harrison et al., “Compendium of Synthetic Organic Methods”, Vols. 1-8 (John Wiley and Sons, 1971-1996); “Beilstein Handbook of Organic Chemistry,” Beilstein Institute of Organic Chemistry, Frankfurt, Germany; Feiser et al., “Reagents for Organic Synthesis,” Volumes 1-21, Wiley Interscience; Trost et al., “Comprehensive Organic Synthesis,” Pergamon Press, 1991; “Theilheimer's Synthetic Methods of Organic Chemistry,” Volumes 1-45, Karger, 1991; March, “Advanced Organic Chemistry,” Wiley Interscience, 1991; Larock “Comprehensive Organic Transformations,” VCH Publishers, 1989; Paquette, “Encyclopedia of Reagents for Organic Synthesis,” 3d Edition, John Wiley & Sons, 1995). Other methods for synthesis of the compounds described herein and/or starting materials are either described in the art or will be readily apparent to the skilled artisan.

A typical synthesis is depicted in Scheme I, wherein 2 equivalents of a phenol or phenol equivalent are condensed with 1 equivalent of a phthalic anhydride or equivalent under essentially acid anhydrous conditions.

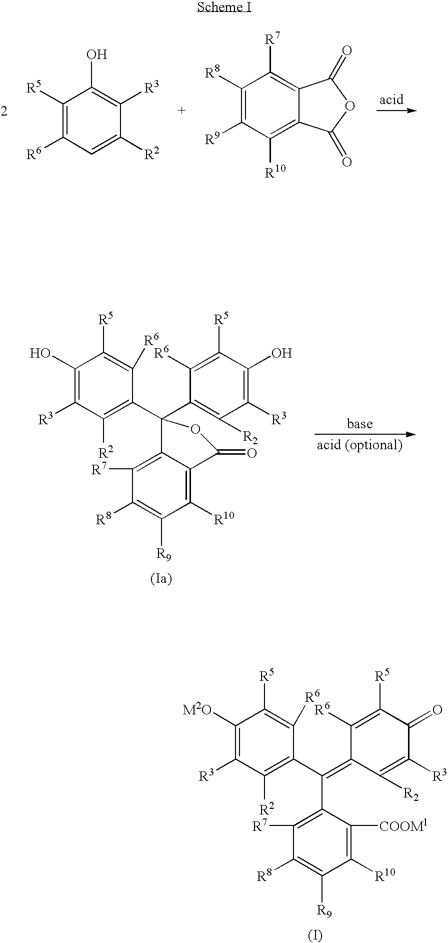

Generally, the phenol and anhydride are condensed in the presence of an acid under anhydrous conditions. For example, polyphosphoric acid and zinc chloride can be utilized. The carbon atom at 4-position-position with respect to the aromatic hydroxyl group must not be substituted as it is necessary for reaction. Polyphosphoric acid acts as a condensing agent as well as reaction medium. The reaction with only polyphosphoric acid afforded tarry products but when very small amount of zinc chloride was added to polyphosphoric acid, clean product was isolated. Very small amount of zinc chloride was found to increase yield and purity of the product. Polyphosphoric acid can be replaced with orthophosphoric acid, chlorosulfonic acid, methane sulfonic acid, trifluoroacetic acid or other acids under anhydrous conditions. Suitable solvents include non-protic solvents known in the art such as tetrahydrofuran, dioxane, methylene chloride, ether, etc.

The reaction proceeds with the formation of an isobenzofuranone (Ia), which is then treated with a base under aqueous conditions. The salt can be isolated or the solution can be acidified to produce the protonated phenol/carboxylic acid. For example, one molar equivalent of Ia was condensed with either two molar equivalent of sodium hydroxide in 85% ethanol or two molar equivalent of sodium ethoxide in ethanol. The products are generally solids and can be easily purified via filtration, crystallization, and other methods known in the art.

Suitable phenols include, but are not limited to 2-nitrophenol, 3-nitrophenol, 2-chlorophenol, 3-chlorophenol, 2-bromophenol, 3-bromophenol, 2-iodophenol, 3-iodophenol, 2-fluorophenol, 3-fluorophenol, 2-aminophenol, 3-aminophenol, 2-acetamidophenol, 3-acetamidophenol, 2-cyanophenol, 3-cyanophenol, 2-methylphenol, 3-methylphenol, 2-ethylphenol, 3-ethylphenol, 2-proylphenol, 3-proylphenol, 2-isoproylphenol, 3-isoproylphenol, 2-butylphenol, 3-butylphenol, 2-isobutylphenol, 3-isobutylphenol, 2-pentylphenol, 3-pentylphenol 2-hexylphenol, 3-hexylphenol, 2-heptylphenol, 3-heptylphenol, 2-octylphenol, 3-octylphenol, 2-nonylphenol, 3-nonylphenol, 2-decylphenol, 3-decylphenol, 2-decylphenol, 2-methoxyphenol, 3-methoxyphenol, 2-ethoxyphenol, 3-ethoxyphenol, 2-propoxyphenol, 3-propoxyphenol, 2-isopropoxyphenol, 3-isopropoxyphenol, 2-butoxyphenol, 3-butoxyphenol, 2-isobutoxyphenol, 3-isobutoxylphenol, 2-allylphenol, 3-allylphenol, 2-vinylphenol, 3-vinylphenol, 2-phenylphenol, 3-phenylphenol, 2-phenoxyphenol, 3-phenoxyphenol, 2-cyclopropylphenol, 3-cyclopropylphenol, 2-cyclobutylphenol, 3-cyclobutylphenol, 2-cyclopentylphenol, 3-cyclopentylphenol, 2-cyclohexylphenol, 3-cyclohexylphenol, 2-cycloheptylphenol, 3-cycloheptylphenol, 2-cyclooctylphenol, 3-cyclooctylphenol, 2-cyclononylphenol, 3-cyclononylphenol, 2-cyclodecylphenol, 3-cyclodecylphenol, 2,3-dinitrophenol, 2,5-dinitrophenol, 2,6-dinitrophenol, 2,3-dimethylphenol, 2,5-dimethylphenol, 2,6-dimethylphenol, 2,3-diethylphenol, 2,5-diethylphenol, 2,6-diethylphenol, 2,3-diproplylphenol, 2,5-dipropylphenol, 2,6-dipropylphenol, 2,3-diisoproplylphenol, 2,5-diisopropylphenol, 2,6-diisopropylphenol, 2,3-dibutylphenol, 2,5-dibutylphenol, 2,6-dibutylphenol, 2,3-diisobutylphenol, 2,5-diisobutylphenol, 2,6-diisobutylphenol, 2,3-dipentylphenol, 2,5-dipentylphenol, 2,6-dipentylphenol, 2,3-dihexylphenol, 2,5-dihexylphenol, 2,6-dihexylphenol, 2,3-diheptylphenol, 2,5-diheptylphenol, 2,6-diheptylphenol, 2,3-dioctylphenol, 2,5-dioctylphenol, 2,6-dioctylphenol, 2,3-dinonylphenol, 2,5-dinonylphenol, 2,6-dinonylphenol, 2,3-didecylphenol, 2,5-didecylphenol, 2,6-didecylphenol, 2,3-dimethoxyphenol, 2,5-dimethoxyphenol, 2,6-dimethoxyphenol, 2,3-diethoxyphenol, 2,5-diethoxyphenol, 2,6-diethoxyphenol, 2,3-dipropoxyphenol, 2,5-dipropoxyphenol, 2,6-dipropoxyphenol, 2,3-diisopropoxyphenol, 2,5-diisopropoxyphenol, 2,6-diisopropoxyphenol, 2,3-dibutoxyphenol, 2,5-dibutoxyphenol, 2,6-dibutoxyphenol, 2,3-diisobutoxyphenol, 2,5-diisobutoxyphenol, 2,6-diisobutoxyphenol, 2,3-dipentoxyphenol, 2,5-dipentoxyphenol, 2,6-dipentoxyphenol, 2,3-dihexoxyphenol, 2,5-dihexoxyphenol, 2,6-dihexoxyphenol, 2,3-diheptoxyphenol, 2,5-diheptoxyphenol, 2,6-diheptoxyphenol, 2,3-dioctoxyphenol, 2,5-dioctoxyphenol, 2,6-dioctoxyphenol, 2,3-dinonoxyphenol, 2,5-dinonoxyphenol, 2,6-dinonoxyphenol, 2,3-didecyloxyphenol, 2,5-didecyloxyphenol, 2,6-didecyloxyphenol, 2,3-dichlorophenol, 2,5-dichlorophenol, 2,6-dichlorophenol, 2,3-dibromophenol, 2,5-dibromophenol, 2,6-dibromophenol, 2,3-diiodophenol, 2,5-diiodophenol, 2,6-diiodophenol, 2,3-difluorophenol, 2,5-difluorophenol, 2,6-difluorophenol, 2,3-diaminophenol, 2,5-diaminophenol, 2,6-diaminophenol, 2,3-diacetamidophenol, 2,5-diacetamidophenol, 2,6-diacetamidophenol, 2,3-dicyanophenol, 2,5-dicyanophenol, 2,6-dicyanophenol, 2,3-diallylphenol, 2,5-diallylphenol, 2,6-diallylphenol, 2,3-divinylphenol, 2,5-divinylphenol, 2,6-divinylphenol, 2,3-diphenylphenol, 2,5-diphenylphenol, 2,6-diphenylphenol, 2,3-diphenoxyphenol, 2,5-diphenoxyphenol, 2,6-diphenoxyphenol, 2,3-dicycloproylphenol, 2,5-dicyclopropylphenol, 2,6-dicyclopropylphenol, 2,3-dicyclobutylphenol, 2,5-dicyclobutylphenol, 2,6-dicyclobutylphenol, 2,3-dicyclopentylphenol, 2,5-dicyclopentylphenol, 2,6-dicyclopentylphenol, 2,3-dicyclohexylphenol, 2,5-dicyclohexylphenol, 2,6-dicyclohexylphenol, 2,3-dicycloheptylphenol, 2,5-dicycloheptylphenol, 2,6-dicycloheptylphenol, 2,3-dicyclooctylphenol, 2,5-dicyclooctylphenol, 2,6-dicyclooctylphenol, 2,3-dicyclononylphenol, 2,5-dicyclononylphenol, 2,6-dicyclononylphenol, 2,3-dicyclodecylphenol, 2,5-dicyclodecylphenol, 2,6-dicyclodecylphenol, 2,3,5-trimethylphenol, 2,3,6-trimethylphenol 2,3,5-triethylphenol, 2,3,6-triethylphenol, 2,3,5-tripropylphenol, 2,3,6-tripropylphenol, 2,3,5-tributylphenol, 2,3,6-tributylphenol, 2,3,5-trichlorophenol, 2,3,6-trichlorophenol, 2,3,5-tribromophenol, 2,3,6-tribromophenol, 2,3,5-triiodophenol, 2,3,6-triiodophenol, 2,3,5-trifluorophenol, 2,3,6-trifluorophenol, 2,3,5-trivinylphenol, 2,3,6-trivinylphenol, 2,3,5-triallylphenol, 2,3,6-triallylphenol, 2,3,5-triphenylphenol, 2,3,6-triphenylphenol, 2,3,5-triphenoxyphenol, 2,3,6-triphenoxyphenol, 2,3,5-trimethoxyphenol, 2,3,6-trimethoxyphenol, 2,3,5-triethoxyphenol, 2,3,6-triethoxyphenol, 2,3,5-tripropoxyphenol, 2,3,6-tripropoxyphenol, 2,3,5-tributoxyphenol, 2,3,6-tributoxyphenol, 2,3,5-trinitrophenol, 2,3,6-trinitrophenol, 2,3,5-triaminophenol, 2,3,6-triaminophenol, 2,3,5-triacetamidophenol, 2,3,6-triacetamidophenol, 2,3,5-tricyanophenol, 2,3,6-tricyanophenol, 3-(N,N-diethylamino)phenol, 2-tert-butyl-5-methylphenol, 2-tert-butyl-6-methylphenol, 3-methyl-2-nitrophenol, 5-methyl-2-nitrophenol, 6-methyl-2-nitrophenol, 3-ethyl-2-nitrophenol, 5-ethyl-2-nitrophenol, 6-ethyl-2-nitrophenol, 3-methoxyl-2-nitrophenol, 5-methoxy-2-nitrophenol, 6-methoxy-2-nitrophenol, 1-naphthaol, 2-naphthaol, 2-nitro-1-naphthol, 3-nitro-1-naphthol, 5-nitro-1-naphthol, 6-nitro-1-naphthol, 7-nitro-1-naphthol, 8-nitro-1-naphthol, 2-methyl-1-naphthol, 3-methyl-1-naphthol, 5-methyl-1-naphthol, 6-methyl-1-naphthol, 7-methyl-1-naphthol, 8-methyl-1-naphthol, 2-methoxy-1-naphthol, 3-methoxy-1-naphthol, 5-methoxy-1-naphthol, 6-methoxy-1-naphthol, 7-methoxy-1-naphthol, 8-methoxy-1-naphthol, 2-chloro-1-naphthol, 3-chloro-1-naphthol, 5-chloro-1-naphthol, 6-chloro-1-naphthol, 7-chloro-1-naphthol, 8-chloro-1-naphthol, 2-bromo-1-naphthol, 3-bromo-1-naphthol, 5-bromo-1-naphthol, 6-bromo-1-naphthol, 7-bromo-1-naphthol, 8-bromo-1-naphthol, 2-iodo-1-naphthol, 3-iodo-1-naphthol, 5-iodo-1-naphthol, 6-iodo-1-naphthol, 7-iodo-1-naphthol, 8-iodo-1-naphthol, 2-fluoro-1-naphthol, 3-fluoro-1-naphthol, 5-fluoro-1-naphthol, 6-fluoro-1-naphthol, 7-bromo-1-naphthol, 8-fluoro-1-naphthol, 2-cyano-1-naphthol, 3-cyano-1-naphthol, 5-cyano-1-naphthol, 6-cyano-1-naphthol, 7-cyano-1-naphthol, 8-cyano-1-naphthol, 8-hydroxyquinaldine and 2-quinoxalinol.

The term “phenol equivalent” is intended to include those compounds where, as described above, R² and R³, for example, form an aromatic, heterocyclic, or non-aromatic ring. Suitable compounds include naphthols for example.

Suitable phthalic anhydrides include but are not limited to phthalic anhydride, 3-nitrophthalic anhydride, 4-nitrophthalic anhydride, 5-nitrophthalic anhydride, 6-nitrophthalic anhydride, 3-chlorophthalic anhydride, 4-chlorophthalic anhydride, 5-chlorophthalic anhydride, 6-chlorophthalic anhydride, 3-bromophthalic anhydride, 4-bromophthalic anhydride, 5-bromophthalic anhydride, 6-bromophthalic anhydride, 3-iodophthalic anhydride, 4-iodophthalic anhydride, 5-iodophthalic anhydride, 6-iodophthalic anhydride, 3-fluorophthalic anhydride, 4-fluorophthalic anhydride, 5-fluorophthalic anhydride, 6-fluorophthalic anhydride, 3-methylphthalic anhydride, 4-methylphthalic anhydride, 5-methylphthalic anhydride, 6-methylphthalic anhydride, 3-ethylphthalic anhydride, 4-ethylphthalic anhydride, 5-ethylphthalic anhydride, 6-ethylphthalic anhydride, 3-methoxyphthalic anhydride, 4-methoxyphthalic anhydride, 5-methoxyphthalic anhydride, 6-methoxyphthalic anhydride, 3-cyanophthalic anhydride, 4-cyanophthalic anhydride, 5-cyanophthalic anhydride, 6-cyanophthalic anhydride, 3-aminophthalic anhydride, 4-aminophthalic anhydride, 5-aminophthalic anhydride, 6-aminophthalic anhydride, 3-acetamidophthalic anhydride, 4-acetamidophthalic anhydride, 5-acetamidophthalic anhydride, 6-acetamidophthalic anhydride, 3,4,5,6-tetrachlorophthalic anhydride, 3,4,5,6-tetrabromophthalic anhydride, 3,4,5,6-tetraiodophthalic anhydride, 3,4,5,6-tetrafluorophthalic anhydride, 3,4,5,6-tetranitrophthalic anhydride, 3,4,5,6-tetramethylphthalic anhydride, 3,4,5,6-tetraethylphthalic anhydride, 3,4,5,6-tetramethoxyphthalic anhydride, 3,4,5,6-tetracyanophthalic anhydride, 3,4,5,6-tetraaminophthalic anhydride, 3,4,5,6-tetraacetamidophthalic anhydride, naphthalic anhydride, 2-chloronaphthalic anhydride, 3-chloronaphthalic anhydride, 4-chloronaphthalic anhydride, 5-chloronaphthalic anhydride, 6-chloronaphthalic anhydride, 7-chloronaphthalic anhydride, 2-bromonaphthalic anhydride, 3-bromonaphthalic anhydride, 4-bromonaphthalic anhydride, 5-bromonaphthalic anhydride, 6-bromonaphthalic anhydride, 7-bromonaphthalic anhydride, 2-iodonaphthalic anhydride, 3-iodonaphthalic anhydride, 4-iodonaphthalic anhydride, 5-iodonaphthalic anhydride, 6-iodonaphthalic anhydride, 7-iodonaphthalic anhydride, 2-fluoronaphthalic anhydride, 3-fluoronaphthalic anhydride, 4-fluoronaphthalic anhydride, 5-fluoronaphthalic anhydride, 6-fluoronaphthalic anhydride, 7-fluoronaphthalic anhydride, 2-nitronaphthalic anhydride, 3-nitronaphthalic anhydride, 4-nitronaphthalic anhydride, 5-nitronaphthalic anhydride, 6-nitronaphthalic anhydride and 7-nitronaphthalic anhydride.

The term “phthalic anhydride equivalent” is intended to include those compounds where, as described above, R⁷ and R⁸, for example, form an aromatic, heterocyclic, or non-aromatic ring. Suitable compounds include naphthols for example.

Synthesis of Phenols and Hydrazides

The compounds of the invention may be obtained via synthetic methods illustrated below. It should be understood that in R², R³, R⁴, R⁵, R⁶, R⁷, R⁸, R⁹, R¹⁰, R¹¹, R¹², R¹³, R¹⁴ and R¹⁵ are as previously defined for structural formulae (II), (III), (IIa) and (IV).

Starting materials useful for preparing compounds of the invention and intermediates thereof are commercially available or can be prepared by well-known synthetic methods (see, e.g., Harrison et al., “Compendium of Synthetic Organic Methods”, Vols. 1-8 (John Wiley and Sons, 1971-1996); “Beilstein Handbook of Organic Chemistry,” Beilstein Institute of Organic Chemistry, Frankfurt, Germany; Feiser et al., “Reagents for Organic Synthesis,” Volumes 1-21, Wiley Interscience; Trost et al., “Comprehensive Organic Synthesis,” Pergamon Press, 1991; “Theilheimer's Synthetic Methods of Organic Chemistry,” Volumes 1-45, Karger, 1991; March, “Advanced Organic Chemistry,” Wiley Interscience, 1991; Larock “Comprehensive Organic Transformations,” VCH Publishers, 1989; Paquette, “Encyclopedia of Reagents for Organic Synthesis,” 3d Edition, John Wiley & Sons, 1995). Other methods for synthesis of the compounds described herein and/or starting materials are either described in the art or will be readily apparent to the skilled artisan.

A typical synthesis for substituted phenols is depicted in Scheme II, wherein a phenol is treated with a base to form the phenolic salt. Advantageously, the phenolic salts are water soluble, which is useful in the applications detailed throughout the specification.

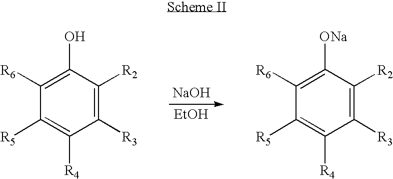

Generally, the phenol mixed with the base and the salt is formed. The solution may be heated to facilitate the rate of reaction.

Suitable phenols include, but are not limited to 2-nitrophenol, 3-nitrophenol, 4-nitrophenol, 2-chlorophenol, 3-chlorophenol, 4-chlorophenol, 2-bromophenol, 3-bromophenol, 4-bromophenol, 2-iodophenol, 3-iodophenol, 4-iodophenol, 2-aminophenol, 3-aminophenol, 4-aminophenol, 2-cyanophenol, 3-cyanophenol, 4-cyanophenol, 2-vinylphenol, 3-vinylphenol, 4-vinylphenol, 2,3-dichlorophenol, 2,4-dichlorophenol, 2,5-dichlorophenol, 2,6-dichlorophenol, 2,3-dibromophenol, 2,4-dibromophenol, 2,5-dibromophenol, 2,6-dibromophenol, 2,3-diiodophenol, 2,4-diiodophenol, 2,5-diiodophenol, 2,6-diiodophenol, 2,3-diaminophenol, 2,4-diaminophenol, 2,5-diaminophenol, 2,6-diaminophenol, 2,3-dicyanophenol, 2,4-dicyanophenol, 2,5-dicyanophenol, 2,6-dicyanophenol, 2,3-divinylphenol, 2,4-divinylphenol, 2,5-divinylphenol, 2,6-divinylphenol, 2,3-diphenylphenol, 2,3,4-trichlorophenol, 2,3,5-trichlorophenol, 2,3,6-trichlorophenol, 2,3,4-tribromophenol, 2,3,5-tribromophenol, 2,3,6-tribromophenol, 2,3,4-triiodophenol, 2,3,5-triiodophenol, 2,3,6-triiodophenol, 2,3,4-trivinylphenol, 2,3,5-trivinylphenol, 2,3,6-trivinylphenol, 2,3,4-trinitrophenol, 2,3,5-trinitrophenol, 2,3,6-trinitrophenol, 2,3,4-triaminophenol, 2,3,5-triaminophenol, 2,3,6-triaminophenol, 2,3,4-tricyanophenol, 2,3,5-tricyanophenol, 2,3,6-tricyanophenol, 3-(N,N-diethylamino)phenol, 3-methyl-2-nitrophenol, 5-methyl-2-nitrophenol, 6-methyl-2-nitrophenol, 3-ethyl-2-nitrophenol, 5-ethyl-2-nitrophenol, 6-ethyl-2-nitrophenol, 3-methoxyl-2-nitrophenol, 5-methoxy-2-nitrophenol, 6-methoxy-2-nitrophenol, 2-nitro-1-naphthol, 3-nitro-1-naphthol, 4-nitro-1-naphthol, 5-nitro-1-naphthol, 6-nitro-1-naphthol, 7-nitro-1-naphthol, 8-nitro-1-naphthol, 2-chloro-1-naphthol, 3-chloro-1-naphthol, 4-chloro-1-naphthol, 5-chloro-1-naphthol, 6-chloro-1-naphthol, 7-chloro-1-naphthol, 8-chloro-1-naphthol, 2-bromo-1-naphthol, 3-bromo-1-naphthol, 4-bromo-1-naphthol, 5-bromo-1-naphthol, 6-bromo-1-naphthol, 7-bromo-1-naphthol, 8-bromo-1-naphthol, 2-iodo-1-naphthol, 3-iodo-1-naphthol, 4-iodo-1-naphthol, 5-iodo-1-naphthol, 6-iodo-1-naphthol, 7-iodo-1-naphthol, 8-iodo-1-naphthol, 2-cyano-1-naphthol, 3-cyano-1-naphthol, 4-cyano-1-naphthol, 5-cyano-1-naphthol, 6-cyano-1-naphthol, 7-cyano-1-naphthol, 8-cyano-1-naphthol and 8-hydroxyquinaldine.

The term “phenol equivalent” is intended to include those compounds where, as described above, R² and R³, for example, form an aromatic, heterocyclic, or non-aromatic ring. Suitable compounds include naphthols for example.

A typical synthesis of hydrazines is depicted in Scheme III, where a hydrazine (NH₂NH—R¹⁵, wherein R¹⁵ can be a hydrogen atom or as described above) and an ester are condensed to form the hydrazide.

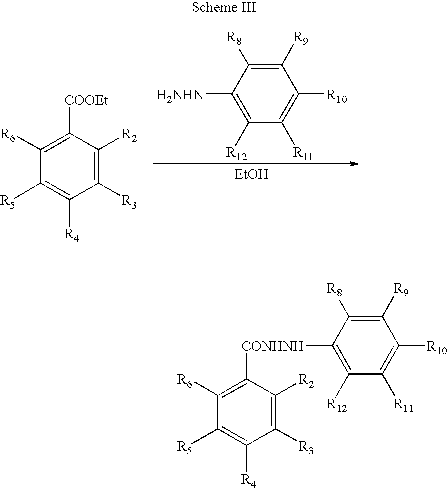

Typically the ester and the hydrazine are combined in a solvent, such as a protic solvent, e.g., an alcohol, such as ethanol, and heated, e.g., to reflux. Upon cooling, the hydrazide generally precipitates from solution and can be collected.

Suitable salicylic derivatives include, but not limited to salicylic acid, 3-methylsalicylic acid, 4-methylsalicylic acid, 5-methylsalicylic acid, 6-methylsalicylic acid, 3-ethylsalicylic acid, 4-ethylsalicylic acid, 5-ethylsalicylic acid, 6-ethylsalicylic acid, 3-propylsalicylic acid, 4-propylsalicylic acid, 5-propylsalicylic acid, 6-propylsalicylic acid, 3-isopropylsalicylic acid, 4-isopropylsalicylic acid, 5-isopropylsalicylic acid, 6-isopropylsalicylic acid, 3-butylsalicylic acid, 4-butylsalicylic acid, 5-butylsalicylic acid, 6-butylsalicylic acid, 3-isobutylsalicylic acid, 4-isobutylsalicylic acid, 5-isobutylsalicylic acid, 6-isobutylsalicylic acid, 3-methoxysalicylic acid, 4-methoxysalicylic acid, 5-methoxysalicylic acid, 6-methoxysalicylic acid, 3-ethoxysalicylic acid, 4-ethoxysalicylic acid, 5-ethoxysalicylic acid, 6-ethoxysalicylic acid, 3-propoxysalicylic acid, 4-propoxysalicylic acid, 5-propoxysalicylic acid, 6-propoxysalicylic acid, 3-butoxysalicylic acid, 4-butoxysalicylic acid, 5-butoxysalicylic acid, 6-butoxysalicylic acid, 3-nitrosalicylic acid, 4-nitrosalicylic acid, 5-nitrosalicylic acid, 6-nitrosalicylic acid, 3-chlorosalicylic acid, 4-chlorosalicylic acid, 5-chlorosalicylic acid, 6-chlorosalicylic acid, 3-bromosalicylic acid, 4-bromosalicylic acid, 5-bromosalicylic acid, 6-bromosalicylic acid, 3-iodosalicylic acid, 4-iodosalicylic acid, 5-iodosalicylic acid, 6-iodoosalicylic acid, 3-fluorosalicylic acid, 4-fluorosalicylic acid, 5-fluorosalicylic acid, 6-fluorosalicylic acid, 3-aminosalicylic acid, 4-aminosalicylic acid, 5-aminosalicylic acid, 6-aminosalicylic acid, 3-acetamidosalicylic acid, 4-acetamidosalicylic acid, 5-acetamidosalicylic acid, 6-acetamidosalicylic acid, 3-cyanosalicylic acid, 4-cyanosalicylic acid, 5-cyanosalicylic acid, 6-cyanosalicylic acid, 3-sulfosalicylic acid, 4-sulfosalicylic acid, 5-sulfosalicylic acid, 6-sulfosalicylic acid, 3,5-dimethylsalicylic acid, 3,5-diethylsalicylic acid, 3,5-dipropylsalicylic acid, 3,5-dibutylsalicylic acid, 3,5-dimethoxysalicylic acid, 3,5-diethoxysalicylic acid, 3,5-dipropoxysalicylic acid, 3,5-dibutoxysalicylic acid, 3,5-dichlorosalicylic acid, 3,5-dibromosalicylic acid, 3,5-diiodosalicylic acid, 3,5-difluorosalicylic acid, 3,5-dinitrosalicylic acid, 3,5-diaminosalicylic acid, 3,5-diacetamidosalicylic acid, 3,5-dicyanosalicylic acid, 3,5-disulfosalicylic acid, substituted/unsubstituted alkyl salicylic acid, substituted/unsubstituted alkoxy salicylic acid, substituted/unsubstituted aryl salicylic acid, substituted/unsubstituted cycloalkyl salicylic acid and substituted/unsubstituted hetaryl salicylic acid.

Suitable hydrazines include but not limited to hydrazine hydrate, 4-nitrophenylhydrazine, 3-nitrophenylhydrazine, 2-nitrophenylhydrazine, 4-nitrobenzoic hydrazide, 3-nitrobenzoic hydrazide, 2-nitrobenzoic hydrazide, p-toluenesulfonylhydrazide, m-toluenesulfonylhydrazide, o-toluenesulfonyl-hydrazide, 2,4-dinitrophenylhydrazine (2,4-DNP), 1-naphthoic hydrazide, 2-naphthoic hydrazide, nicotinic hydrazide, substituted/unsubstituted alkyl hydrazide, substituted/unsubstituted alkoxy hydrazide, substituted/unsubstituted aryl hydrazide, substituted/unsubstituted cycloalkyl hydrazide and substituted/unsubstituted hetaryl hydrazide.

Additional surfactants useful in cleansing compositions and lotions

Suitable surfactants include anionic, cationic, nonionic or zwitterionic compounds and combinations thereof. The surfactant can be either polymeric or non-polymeric.

The term “surfactant” is recognized in the relevant art to include those compounds which modify the nature of surfaces, e.g. reducing the surface tension of water. Surfactants are generally classified into four types: cationic (e.g. modified onium salts, where part of the molecule is hydrophilic and the other consists of straight or branches long hydrocarbon chains such as hexadecyltrimethyl bromide), anionic, also known as amphiphatic agents (e.g., alkyl or aryl or alkylarylsulfonates, carboxylates, phosphates), nonionic (e.g., polyethylene oxides, alcohols) and ampholytic or amphoteric (e.g. dodecyl-beta-alanine, such that the surfactant contains a zwitterionic group). One or more surfactants can be used in the present invention.

Cationic surfactants useful as surface tension reducing agents in the present invention include long chain hydrocarbons which contain quaternarized heteroatoms, such as nitrogen. Suitable cationic surfactants include quaternary ammonium compounds in which typically one of the groups linked to the nitrogen atom is a C12-C18 alkyl group and the other three groups are short chained alkyl groups.

Anionic surfactants (amphiphatic agents) are characterized by a single lipophilic chain and a polar head group which can include sulfate, sulfonate, phosphate, phosphonate and carboxylate. Exemplary compounds include linear sodium alkyl benzene sulfonate (LAS), linear alkyl sulfates and phosphates, such as sodium lauryl sulfate (SLS) and linear alkyl ethoxy sulfates. Additional examples of anionic surfactants include substituted ammonium (e.g., mono-, di-, and tri-ethanolammonium), alkali metal and alkaline earth metal salts of C6-C20 fatty acids and rosin acids, linear and branched alkyl benzene sulfonates, alkyl ether sulfates, alkane sulfonates, olefin sulfonates, hydroxyalkane sulfonates, fatty acid monoglyceride sulfates, alkyl glyceryl ether sulfates, acyl sarcosinates. acyl N-methyltaurides, and alkylaryl sulfonated surfactants, such as alkylbenezene sulfonates.

Nonionic surfactants do not dissociate but commonly derive their hydrophilic portion from polyhydroxy or polyalkyloxy structures. Suitable examples of polyhydroxy(polyhydric) compounds include ethylene glycol, butylene glycol,1,3-butylene glycol, propylene glycol, glycerine, 2-methyl-1,3-propane diol, glycerol, mannitol, corn syrup, beta-cyclodextrin, and amylodextrin. Suitable examples of polyalkyloxy compounds include diethylene glycol, dipropylene glycol, polyethylene glycols, polypropylene glycols and glycol derivatives.

Other suitable nonionic surfactants include other linear ethoxylated alcohols with an average length of 6 to 16 carbon atoms and averaging about 2 to 20 moles of ethylene oxide per mole of alcohol; linear and branched, primary and secondary ethoxylated, propoxylated alcohols with an average length of about 6 to 16 carbon atoms and averaging 0-10 moles of ethylene oxide and about 1 to 10 moles of propylene oxide per mole of alcohol; linear and branched alkylphenoxy (polyethoxy) alcohols, otherwise known as ethoxylated alkylphenols, with an average chain length of 8 to 16 carbon atoms and averaging 1.5 to 30 moles of ethylene oxide per mole of alcohol; and mixtures thereof.

Additionally, suitable nonionic surfactants include polyoxyethylene carboxylic acid esters, fatty acid glycerol esters, fatty acid and ethoxylated fatty acid alkanolamides. Block copolymers of propylene oxide and ethylene oxide, and block polymers of propylene oxide and ethylene oxide with propoxylated ethylene diamine are also included as acceptable nonionic surfactants. Semi-polar nonionic surfactants like amine oxides, phosphine oxides, sulfoxides, and their ethoxylated derivatives are included within the scope of the invention.

Suitable amphoteric and zwitterionic surfactants which contain an anionic water-solubilizing group, a cationic group and a hydrophobic organic group include amino carboxylic acids and their salts, amino dicarboxylic acids and their salts, alkylbetaines, alkyl aminopropylbetaines, sulfobetaines, alkyl imidazolinium derivatives, certain quaternary ammonium compounds, certain quaternary phosphonium compounds and certain tertiary sulfonium compounds

Examples of anionic, nonionic, cationic and amphoteric surfactants that are suitable for use in the present invention are described in Kirk-Othmer, Encyclopedia of Chemical Technology, Third Edition, Volume 22, pages 347-387, and McCutcheon's Detergents and Emulsifiers, North American Edition, 1983, both of which are incorporated herein by reference.

Typical concentration ranges of surfactant that are useful in the present compositions are from about 0.01 parts by weight to about 90 parts by weight, from about 0.5 part by weight to about 50 parts by weight, and from about 1 parts by weight to about 10 parts by weight.

In one aspect, surfactants useful in the compositions of the invention include, but are not limited to, cellulose ethers or mixtures with other surfactants, which are water soluble. Cellulose ether surfactants have unique foaming properties which make them ideal for foaming hand soap applications. Cellulose ethers used in the present invention include methyl cellulose, ethyl cellulose, propyl cellulose, butyl cellulose, higher alkyl, aryl, alkoxy, cycloalkyl celluloses, hydroxypropyl cellulose, hydroxybutyl cellulose or mixtures thereof.

Commercial cellulose ether surfactants include, but are not limited to, Methocel A4M, methyl cellulose, Methocel F4M, hydroxypropyl methylcellulose, Methocel K4M, hydroxypropyl methylcellulose, manufactured by Dow Chemical Co., Mildland, Mich.; Natrosol, hydroxyethyl cellulose, Klucel, hydroxypropyl cellulose, Aqualon Cellulose Gum, sodium carboxymethyl cellulose, Hercules Inc., Wilmington, Del.; Elfacos CD 481, ethyl 2-hydroxyethyl ether cellulose, manufactured by Akzo Nobel, Chicago, Ill.

Cellulose ether surfactants are generally present in amounts from about 1% up to about 40% by weight in the compositions of the invention. Suitable concentrations of cellulose ether surfactants are in the range of about 2% to about 30% by weight and from about 3% to about 8% by weight. A particularly useful cellulosic ether surfactant in the compositions is Methocel A4M.

In another aspect, alkanolamide or a mixture with other surfactants can be used in the compositions of the invention. Alkanolamides are commercially available and are the reaction products of one or more fatty acids having 12 or more carbon atoms and a lower alkanolamime. Typical alkanolamides are formed by reaction between stearic, mystiric, lauric acid or mixtures thereof with mono-, di-, and/or iso-propanolamine.

Alkanolamides can be present in the compositions of the invention in the ranges generally described throughout the application but generally are present in amounts from about 0% up to about 10% by weight. Suitable ranges include from about 1% to about 6% by weight and in particular from about 1.5% to about 4% by weight.

In one embodiment, the alkanolamide surfactants of the present invention include, but are not limited to, Ninol 55LL, diethanolamine, Ninol 40CO, cocamide DEA, Ninol 30LL, lauramide DEA, manufactured by Stepan Co., Northfield, Ill.; Colamid C, cocamide DEA, Colamid 0071-J, alkanolamide, manufactured by Colonial Chemical Inc., S. Pittsburgh, Tenn. In one aspect, the alkanolamides are Ninol 55LL, and Colamid C.

Exemplary sulfosuccinates that can be employed in the present compositions include, but are not limited to, Stepan-Mild SL3-BA, disodium laureth sulfosuccinate, Stepan-Mild LSB, sodium lauryl sulfosuccinate, manufactured by Stepan Co., Northfield, Ill., Lankropol 4161L, sodium fatty alkanolamide sulfosuccinate and Colamate-DSLS, disodium laureth sulfosuccinate, manufactured by Colonial Chemical Inc., S. Pittsburgh, Tenn.

Suitable betaines that can be employed in the present compositions include, but are not limited to, Miracare BC-27, cocamidopropyl betaine and Miranol Ultra C-37, sodium cocoampho acetate, manufactured by J & S Chemical Co., Weston, Fla.

Suitable sulfates that can be employed in the present compositions include Rhodapex ES-2, sodium laureth sulfate, J & S Chemical Co., Weston, Fla.; Witcolate WAQ, sodium alkyl sulfate, manufactured by Akzo Nobel, Chicago, I and Colonial-SLS, sodium lauryl sulfate, manufactured by Colonial Chemical Inc., S. Pittsburgh, Tenn. Colonial-SLS surfactant is a combination of lauryl sulfate, C10-C16 alkyl alcohols, sodium salts and C10-C16 alcohols.

A suitable nonionic surfactant that can be employed in the present compositions is Triton H-66, alkyl aryl alkoxy potassium salt, manufactured by Dow Chemical Co., Mildland, Mich.

Synthesis of Acid-Base Indicators:

Reaction medium/condensing agent: Polyphosphoric acid, orthophosphoric acid, chloro sulfonic acid, methane sulfonic acid, trifluoroacetic acid or other acids under anhydrous conditions.

Lewis acid catalyst: Zinc chloride, aluminum chloride, boron trifluoride

### EXAMPLE 1

### Synthesis of 3,3-bis-(4-hydroxy-3-isopropylphenyl)-1-(3H)-isobenzofuranone

A mixture of 2-isopropylphenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-isopropylphenyl)-1-(3H)-isobenzofuranone in 96% yield.

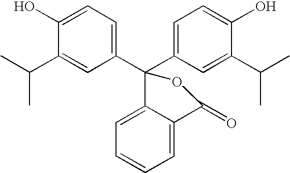

### EXAMPLE 2

### Synthesis of 3,3-bis-(4-hydroxy-3,5-diisopropylphenyl)-1-(3H)-isobenzofuranone

A mixture of 2,6-diisopropylphenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3,5-diisopropylphenyl)-1-(3H)-isobenzofuranone in 98% yield.

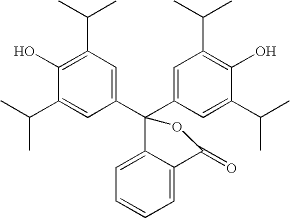

### EXAMPLE 3

### Synthesis of 3,3-bis-(4-hydroxy-2-nitrophenyl)-1-(3H)-isobenzofuranone

A mixture of 3-nitrophenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-2-nitrophenyl)-1-(3H)-isobenzofuranone in 81% yield.

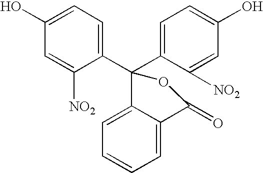

### EXAMPLE 4

### Synthesis of 3,3-bis-(4-hydroxy-3-nitrophenyl)-1-(3H)-isobenzofuranone

A mixture of 2-nitrophenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-nitrophenyl)-1-(3H)-isobenzofuranone in 89% yield.

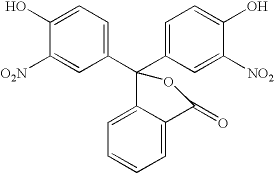

### EXAMPLE 5

### Synthesis of 3,3-bis-[4-hydroxy-2-(N,N-diethylamino)phenyl]-1-(3H)-isobenzofuranone

A mixture of 3-(N,N-diethylamino)phenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-[4-hydroxy-2-(N,N-diethylamino)phenyl]-1-(3H)-isobenzofuranone in 93% yield.

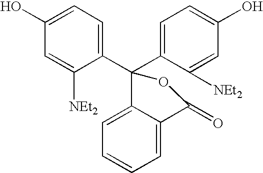

### EXAMPLE 6

### Synthesis of 3,3-bis-(4-hydroxy-3-ethylphenyl)-1-(3H)-isobenzofuranone

A mixture of 2-ethylphenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-ethylphenyl)-1-(3H)-isobenzofuranone in 92% yield.

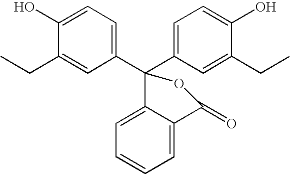

### EXAMPLE 7

### Synthesis of 3,3-bis-(4-hydroxy-3-ethoxyphenyl)-1-(3H)-isobenzofuranone

A mixture of 2-ethoxyphenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-ethoxyphenyl)-1-(3H)-isobenzofuranone in 85% yield.

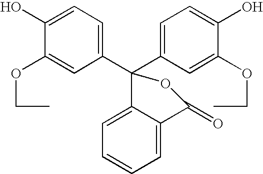

### EXAMPLE 8

### Synthesis of 3,3-bis-(4-hydroxy-3-acetamidophenyl)-1-(3H)-isobenzofuranone

A mixture of 2-acetamidophenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-acetamidophenyl)-1-(3H)-isobenzofuranone in 83% yield.

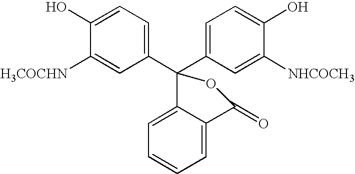

### EXAMPLE 9

### Synthesis of 3,3-bis-(4-hydroxy-6-methyl-3-nitrophenyl)-1-(3H)-isobenzofuranone

A mixture of 5-methyl-2-nitrophenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-6-methyl-3-nitrophenyl)-1-(3H)-isobenzofuranone in 81% yield.

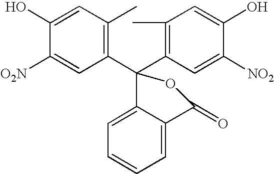

### EXAMPLE 10

### Synthesis of 3,3-bis-(4-hydroxy-6-methyl-5-quinolin-1-yl)-1-(3H)-isobenzofuranone

A mixture of 8-hydroxyquinaldine (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-6-methyl-5-quinolin-1-yl)-1-(3H)-isobenzofuranone in 88% yield.

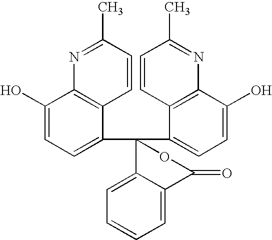

### EXAMPLE 11

### Synthesis of 3,3-bis-(4-hydroxy-3-pyridin-1-yl)-1-(3H)-isobenzofuranone

A mixture of 2-hydroxypyridine (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-pyridin-1-yl)-1-(3H)-isobenzofuranone in 80% yield.

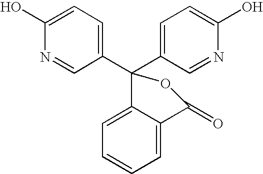

### EXAMPLE 12

### Synthesis of 3,3-bis-(4-hydroxy-2-pyridin-1-yl)-1-(3H)-isobenzofuranone

A mixture of 3-hydroxypyridine (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-2-pyridin-1-yl)-1-(3H)-isobenzofuranone in 82% yield.

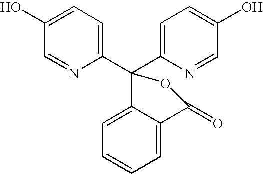

### EXAMPLE 13

### Synthesis of 3,3-bis-(4-hydroxy-3-phenylphenyl)-1-(3H)-isobenzofuranone

A mixture of 2-phenylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3-phenylphenyl)-1-(3H)-isobenzofuranone as white crystals in 94% yield. ¹H-NMR (DMSO-d₆, 300 MHz): δ 9.89 (s, 2H, 20H), 6.97-7.18 (m, 6H, aromatic), 7.26-7.47 (m, 10H, aromatic), 7.63-7.92 (m, 4H, aromatic) ppm. Mass spectra: m/z 470 (M⁺).

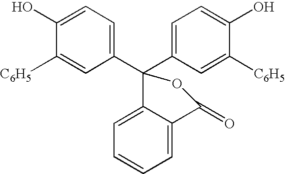

### EXAMPLE 14

### Synthesis of 3,3-bis-(4-hydroxy-3,5-diisopropylphenyl)-1-(3H)-isobenzofuranone

A mixture of 2,6-diisopropylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3,5-diisopropylphenyl)-1-(3H)-isobenzofuranone as white crystals in 89% yield. IR (KBr): 3506, 1734, 1609 cm⁻¹. ¹H-NMR (DMSO-d₆): δ 9.56 (s, 2H, 2OH), 1.02-1.05 (dd, 24H, 8CH₃), 3.22-3.31 (heptate, 4H, 4CH), 6.74-7.00 (m, 4H, aromatic), 7.59-7.92 (m, 4H, aromatic) ppm. Mass spectra: m/z 486 (M⁺).

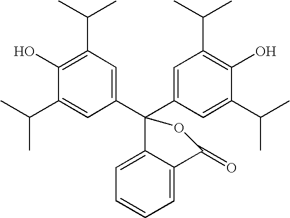

### EXAMPLE 15

### Synthesis of 3,3-bis-(4-hydroxy-3,5-dimethoxyphenyl)-1-(3H)-isobenzofuranone

A mixture of 2,6-dimethoxyphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3,5-dimethoxyphenyl)-1-(3H)-isobenzofuranone as white crystals in 84% yield. IR (KBr): 3388, 1769, 1606, 1369 cm⁻¹. ¹H-NMR (DMSO-d₆): δ 8.71 (s, 2H, 2OH), 3.66 (s, 12H, 4OCH₃), 7.65-7.68 (m, 4H, aromatic), 7.83-7.96 (m, 4H, aromatic) ppm. Mass spectra: m/z 438 (M⁺).

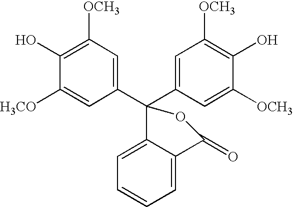

### EXAMPLE 16

### Synthesis of 3,3-bis-(4-hydroxy-3,5-dimethylphenyl)-1-(3H)-isobenzofuranone

A mixture of 2,6-dimethylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3,5-dimethylphenyl)-1-(3H)-isobenzofuranone as white crystals in 91% yield. IR (KBr): 3582, 3386, 1746, 1605 cm⁻¹. ¹H-NMR (DMSO-d₆): δ 8.45 (s, 2H, 2OH), 2.10 (s, 12H, 4CH₃), 7.58-7.63 (m, 4H, aromatic), 7.78-7.87 (m, 4H, aromatic) ppm. Mass spectra: m/z 374 (M⁺).

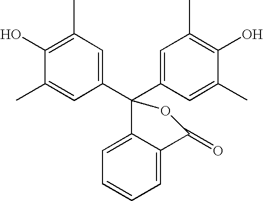

### EXAMPLE 17

### Synthesis of 3,3-bis-(4-hydroxy-3,6-diimethylphenyl)-1-(3H)-isobenzofuranone

A mixture of 2,5-dimethylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3,6-diimethylphenyl)-1-(3H)-isobenzofuranone as pale yellow crystals in 85% yield. IR (KBr): 3393, 1729, 1611 cm⁻¹. ¹H-NMR (DMSO-d₆): δ 9.40 (s, 2H, 2OH), 1.95 (s, 12H, 4CH₃), 6.59-6.63 (m, 4H, aromatic), 7.46-7.91 (m, 4H, aromatic) ppm. Mass spectra: m/z 374 (M⁺).

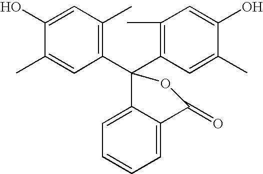

### EXAMPLE 18

### Synthesis of 3,3-bis-(4-hydroxy-3-ethylphenyl)-1-(3H)-isobenzofuranone

A mixture of 2-ethylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from ethyl acetate:petroleum ether (1:1) with charcoal treatment furnished pure 3,3-bis-(4-hydroxy-3-ethylphenyl)-1-(3H)-isobenzofuranone as white crystals in 81% yield. IR (KBr): 3389, 1783, 1718, 1605 cm⁻¹. ¹H-NMR (DMSO-d₆): δ 9.54 (s, 2H, 2OH), 2.43-2.50 (q, 4H, 2CH₂), 1.00-1.05 (t, 6H, 2CH₃), 6.74-6.96 (m, 6H, aromatic), 7.57-7.89 (m, 4H, aromatic) ppm. Mass spectra: m/z 374 (M⁺).

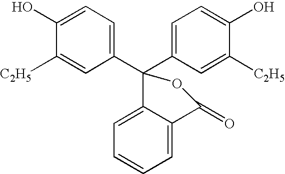

### EXAMPLE 19

### Synthesis of 3,3-bis-(4-hydroxy-3-isopropylphenyl)-1-(3H)-isobenzofuranone

A mixture of 2-isopropylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol:water (1:1) with charcoal treatment furnished pure 33,3-bis-(4-hydroxy-3-isopropylphenyl)-1-(3H)-isobenzofuranone as white crystals in 83% yield. IR (KBr): 3383, 1733, 1608 cm⁻¹. ¹H-NMR (DMSO-d₆): δ 9.57 (s, 2H, 2OH), 1.05-1.07 (dd, 12H, 4CH₃), 3.11-3.18 (heptate, 2H, 2CH), 6.75-7.01 (m, 6H, aromatic), 7.59-7.90 (m, 4H, aromatic) ppm. Mass spectra: m/z 402 (M⁺).

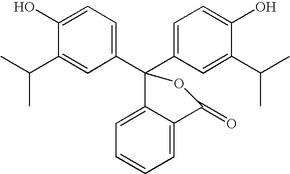

### EXAMPLE 20

### Synthesis of 3,3-bis-(4-hydroxy-3-methoxyphenyl)-1-(3H)-isobenzofuranone

A mixture of 2-methoxyphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3-methoxyphenyl)-1-(3H)-isobenzofuranone as white crystals in 79% yield. IR (KBr): 3517, 1747, 1701, 1279 cm⁻¹. ¹H-NMR (DMSO-d₆): δ 9.27 (s, 2H, 2OH), 3.66 (s, 6H, 2OCH₃), 6.65-6.78 (m, 6H, aromatic), 7.61-7.90 (m, 4H, aromatic) ppm. Mass spectra: m/z 378 (M⁺).

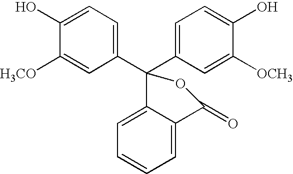

### EXAMPLE 21

### Synthesis of 3,3-bis-(4-hydroxy-2,3,5-trimethylphenyl)-1-(3H)-isobenzofuranone

A mixture of 2,3,6-trimethylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-2,3,5-trimethylphenyl)-1-(3H)-isobenzofuranone as white crystals in 73% yield. IR (KBr): 3510, 3390, 1746, 1609, cm⁻¹. ¹H-NMR (DMSO-d₆): δ 9.44 (s, 2H, 2OH), 2.05 (s, 18H, 6CH₃), 6.55 (s, 2H, aromatic), 7.46-7.90 (m, 4H, aromatic) ppm. Mass spectra: m/z 402 (M⁺).

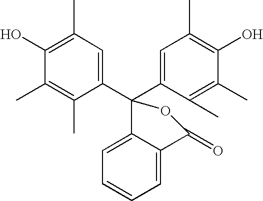

### EXAMPLE 22

### Synthesis of 3,3-bis-(4-hydroxy-3-sec-butylphenyl)-1-(3H)-isobenzofuranone

A mixture of 2-sec-butylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3-sec-butylphenyl)-1-(3H)-isobenzofuranone as white crystals in 77% yield. IR (KBr): 3400, 1722, 1607 cm⁻¹. ¹H-NMR (DMSO-d₆): δ 9.50 (s, 2H, 2OH), 0.80 (t, 6H, 2CH₃), 1.35-1.39 (p, 4H, 2CH₂), 1.22 (d, 6H, 2CH₃), 2.89-2.97 sextate, 2H, 2CH), 6.73-6.93 (m, 6H, aromatic), 7.59-7.90 (m, 4H, aromatic) ppm. Mass spectra: m/z 430 (M⁺).

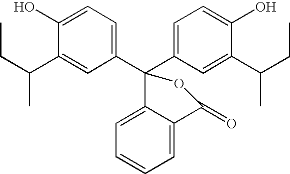

### EXAMPLE 23

### Synthesis of 3,3-bis-(4-hydroxy-3-nitrophenyl)-1-(3H)-isobenzofuranone

A mixture of phenolphthalein (0.062 mol) in acetic acid (290 mL) was stirred at 15° C. Concentrated nitric acid (0.136 mol, 65%) in acetic acid (10 mL) was slowly added to stirring mixture at 15° C. The reaction mixture was further stirred for 6 hours at room temperature and added to ice-water mixture when the yellow colored product precipitated. The product was filtered, thoroughly washed with water and dried. Recrystallization from ethanol with charcoal treatment furnished pure 3,3-bis-(4-hydroxy-3-nitrophenyl)-1-(3H)-isobenzofuranone as pale yellow crystals in 78% yield. IR (KBr): 3262, 1766, 1627, 1538, 1423 cm⁻¹. ¹H-NMR (DMSO-d₆): δ 9.67 (s, 2H, 2OH), 6.71-7.16 (m, 6H, aromatic), 7.46-7.98 (m, 4H, aromatic) ppm. Mass spectra: m/z 408 (M⁺).

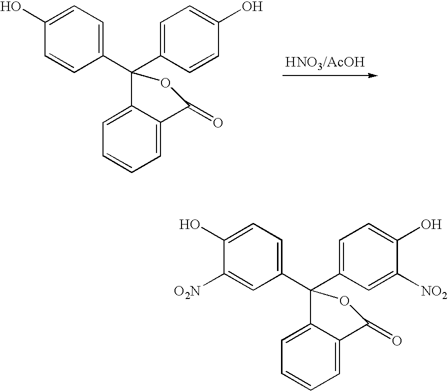

Synthesis of disodium salts of acid-base indicators for water based systems:

### EXAMPLE 1

### Synthesis of disodium salt of 3,3-bis-(4-hydroxy-3-isopropylphenyl)-1-(3H)-isobenzofuranone

A mixture of 3,3-bis-(4-hydroxy-3-isopropylphenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 98% yield.

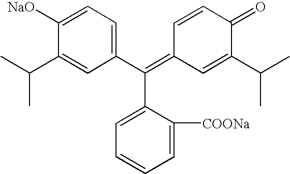

### EXAMPLE 2

### Synthesis of disodium salt of 3,3-bis-(4-hydroxy-3,5-diisopropylphenyl)-1-(3 H)-isobenzofuranone

A mixture of 3,3-bis-(4-hydroxy-3,5-diisopropylphenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 94% yield.

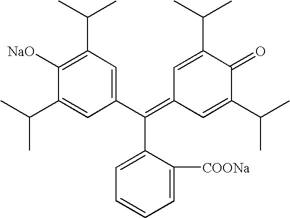

### EXAMPLE 3

### Synthesis of disodium salt of 3,3-bis-(4-hydroxy-2-nitrophenyl)-1-(3H)-isobenzofuranone

A mixture of 3,3-bis-(4-hydroxy-2-nitrophenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 88% yield.

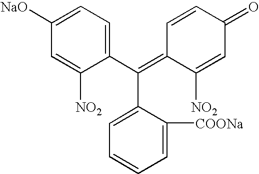

### EXAMPLE 4

### Synthesis of disodium salt of 3,3-bis-(4-hydroxy-3-nitrophenyl)-1-(3H)-isobenzofuranone

A mixture of 3,3-bis-(4-hydroxy-3-nitrophenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 91% yield.

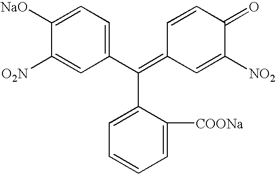

### EXAMPLE 5

### Synthesis of disodium salt of 3,3-bis-[4-hydroxy-2-(N,N-diethylamino)phenyl]-1-(3H)-isobenzofuranone

A mixture of 3,3-bis-[4-hydroxy-2-(N,N-diethylamino)phenyl]-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure, disodium salt in 89% yield.

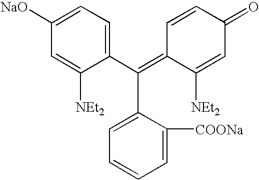

### EXAMPLE 6

### Synthesis of disodium salt of 3,3-bis-(4-hydroxy-3-ethylphenyl)-1-(3H)-isobenzofuranone

A mixture of 3,3-bis-(4-hydroxy-3-ethylphenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 97% yield.

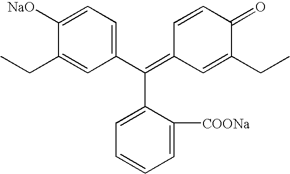

### EXAMPLE 7

### Synthesis of disodium salt of 3,3-bis-(4-hydroxy-3-ethoxyphenyl)-1-(3H)-isobenzofuranone

A mixture of 3,3-bis-(4-hydroxy-3-ethoxyphenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 94% yield.

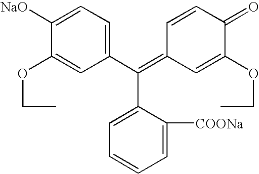

### EXAMPLE 8

### Synthesis of disodium salt of 3,3-bis-(4-hydroxy-3-acetamidophenyl)-1-(3H)-isobenzofuranone

A mixture of 3,3-bis-(4-hydroxy-3-acetamidophenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 92% yield.

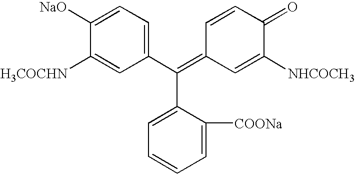

### EXAMPLE 9

### Synthesis of disodium salt of 3,3-bis-(4-hydroxy-6-methyl-3-nitrophenyl)-1-(3H)-isobenzofuranone

A mixture of 3,3-bis-(4-hydroxy-6-methyl-3-nitrophenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 97% yield.

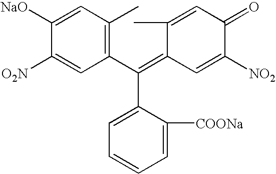

### EXAMPLE 10

### Synthesis of disodium salt of 3,3-bis-(4-hydroxy-6-methyl-5-quinolin-1-yl)-1-(3H)-isobenzofuranone

A mixture of 3,3-bis-(4-hydroxy-6-methyl-5-quinolin-1-yl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 94% yield.

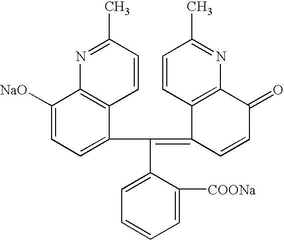

### EXAMPLE 11

### Synthesis of disodium salt of 3,3-bis-(4-hydroxy-3-pyridin-1-yl)-1-(3H)-isobenzofuranone

A mixture of 3,3-bis-(4-hydroxy-3-pyridin-1-yl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 81% yield.

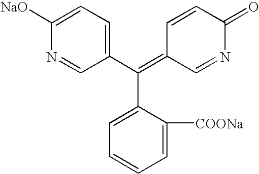

### EXAMPLE 12

### Synthesis of disodium salt of 3,3-bis-(4-hydroxy-2-pyridin-1-yl)-1-(3H)-isobenzofuranone

A mixture of 3,3-bis-(4-hydroxy-2-pyridin-1-yl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 84% yield.

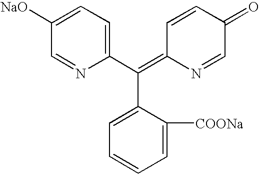

### EXAMPLE 13

### Synthesis of disodium salt of 3,3-bis-(4-hydroxy-3-phenylphenyl)-1-(3H)-isobenzofuranone

A mixture of 3,3-bis-(4-hydroxy-3-phenylphenyl)-1-(3H)-isobenzofuranone (0.01mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 96% yield. ¹H-NMR (DMSO-d₆, 300 MHz): δ 6.25-6.74 (m, 6H, aromatic), 6.88-7.45 (m, 10H, aromatic), 7.53-7.84 (m, 4H, aromatic) ppm. Mass spectra: m/z 514 (M⁺).

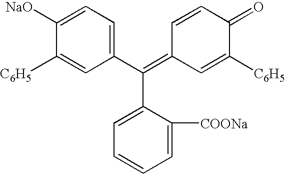

### EXAMPLE 14

### Synthesis of disodium salt of 3,3-bis-(4-hydroxy-3,5-diisopropylphenyl)-1-(3H)-isobenzofuranone

A mixture of 3,3-bis-(4-hydroxy-3,5-diisopropylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 92% yield. ¹H-NMR (DMSO-d₆): δ 1.00-1.21 (dd, 24H, 8CH₃), 3.06-3.36 (heptate, 4H, 4CH), 6.74-6.96 (m, 4H, aromatic), 7.05-7.83 (m, 4H, aromatic) ppm. Mass spectra: m/z 530 (M⁺).

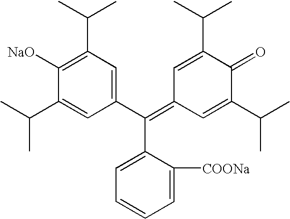

### EXAMPLE 15

### Synthesis of disodium salt of 3,3-bis-(4-hydroxy-3,5-dimethoxyphenyl)-1-(3H)-isobenzofuranone

A mixture of 3,3-bis-(4-hydroxy-3,5-dimethoxyphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 90% yield. ¹H-NMR (DMSO-d₆): δ 3.61 (s, 12H, 4OCH₃), 6.45-6.52 (m, 4H, aromatic), 7.04-7.78 (m, 4H, aromatic) ppm. Mass spectra: m/z 482 (M⁺).

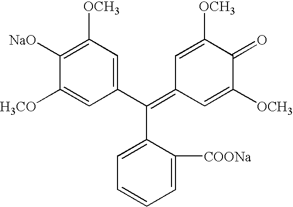

### EXAMPLE 16

### Synthesis of disodium salt of 3,3-bis-(4-hydroxy-3,5-dimethylphenyl)-1-(3H)-isobenzofuranone

A mixture of 3,3-bis-(4-hydroxy-3,5-dimethylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 95% yield. ¹H-MMR (DMSO-d₆): δ 2.11 (s, 12H, 4CH₃), 6.81-6.87 (m, 4H, aromatic), 7.23-7.84 (m, 4H, aromatic) ppm. Mass spectra: m/z 418 (M⁺).

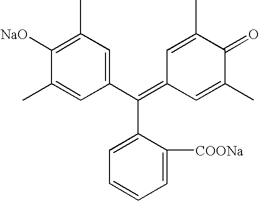

### EXAMPLE 17

### Synthesis of disodium salt of 3,3-bis-(4-hydroxy-3,6-diimethylphenyl)-1-(3H)-isobenzofuranone

A mixture of 3,3-bis-(4-hydroxy-3,6-diimethylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 88% yield. ¹H-NMR (DMSO-d₆): δ 2.01 (s, 12H, 4CH₃), 6.04-6.82 (m, 4H, aromatic), 7.10-7.72 (m, 4H, aromatic) ppm. Mass spectra: m/z 418 (M⁺).

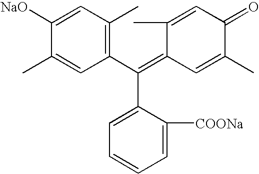

### EXAMPLE 18

### Synthesis of disodium salt of 3,3-bis-(4-hydroxy-3-ethylphenyl)-1-(3H)-isobenzofuranone

A mixture of 3,3-bis-(4-hydroxy-3-ethylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 86% yield. ¹H-NMR (DMSO-d₆): δ 2.30-2.51 (q, 4H, 2CH₂), 1.00-1.10 (t, 6H, 2CH₃), 6.20-6.75 (m, 6H, aromatic), 7.12-7.84 (m, 4H, aromatic) ppm. Mass spectra: m/z 418 (M⁺).

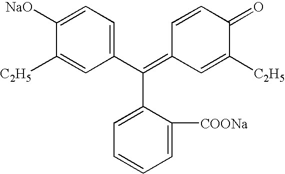

### EXAMPLE 19

### Synthesis of disodium salt of 3,3-bis-(4-hydroxy-3-isopropylphenyl)-1-(3H)-isobenzofuranone

A mixture of 3,3-bis-(4-hydroxy-3-isopropylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 81% yield. ¹H-NMR (DMSO-d₆): δ 1.02-1.14 (dd, 12H, 4CH₃), 3.12-3.45 (heptate, 2H, 2CH), 6.32-6.76 (m, 6H, aromatic), 7.30-7.83 (m, 4H, aromatic) ppm. Mass spectra: m/z 446 (M⁺).

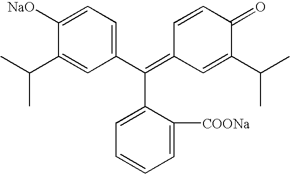

### EXAMPLE 20

### Synthesis of disodium salt of 3,3-bis-(4-hydroxy-3-methoxyphenyl)-1-(3H)-isobenzofuranone

A mixture of 3,3-bis-(4-hydroxy-3-methoxyphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 88% yield.

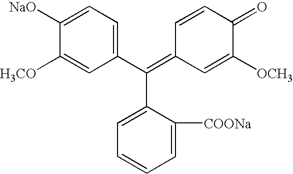

### EXAMPLE 21

### Synthesis of disodium salt of 3,3-bis-(4-hydroxy-2,3,5-trimethylphenyl)-1-(3H)-isobenzofuranone

A mixture of 3,3-bis-(4-hydroxy-2,3,5-trimethylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 80% yield.

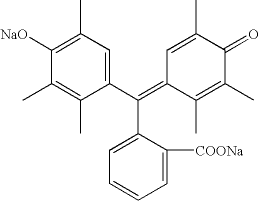

### EXAMPLE 22

### Synthesis of disodium salt of 3,3-bis-(4-hydroxy-3-sec-butylphenyl)-1-(3H)-isobenzofuranone

A mixture of 3,3-bis-(4-hydroxy-3-sec-butylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 82% yield. ¹H-NMR (DMSO-d₆): δ 0.80 (t, 6H, 2CH₃), 1.29-1.37 (p, 4H, 2CH₂), 1.20 (d, 6H, 2CH₃), 2.88-2.96 (sextate, 2H, 2CH), 6.08-6.75 (m, 6H, aromatic), 7.37-7.81 (m, 4H, aromatic) ppm.

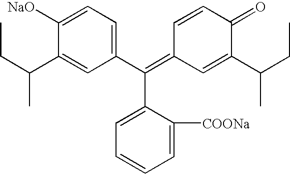

### EXAMPLE 23

### Synthesis of disodium salt of 3,3-bis-(4-hydroxy-3-nitrophenyl)-1-(3H)-isobenzofuranone

A mixture of 3,3-bis-(4-hydroxy-3-nitrophenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 92% yield.

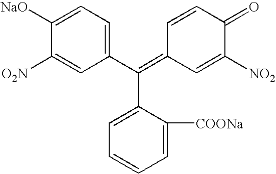

Testing procedure of Consumer Products

The following samples were prepared as follows. 10 g of sample, thymolphthalein (0.3 g), sodium hydroxide (0.05 g), DI water (1 mL) were stirred at room temperature for 2 hrs. The solution became blue colored.

Miracle Gro was more acidic and needed twice the amount of sodium hydroxide than the rest of the samples

Results/Conclusion:

Spectracide Weed stop for lawns by Spectrum: Tested on glass by putting few drops of the formulation on clean glass plate and spreading with plastic pipette, blue to colorless in 45 seconds by exposure to air.

Resolve carpet stain remover for pet stains by Reckitt Benckiser: Tested on carpet by putting few drops of the formulation on carpet and spreading with plastic pipette, blue to colorless in 15 seconds by exposure to air

Miracle-gro LiqudFeed plant food by Scotts Miracle-Gro: Tested on glass by putting few drops of the formulation on clean glass plate and spreading with plastic pipette, blue to colorless in 20 seconds by exposure to air.

Hartz Advance care 3 in 1 Dog Spray Kills Fleas and Ticks by Hartz: Tested on glass by putting few drops of the formulation on clean glass plate and spreading with plastic pipette, blue to colorless in 1 minute 10 seconds by exposure to air.

Tilex Daily shower cleaner by Clorox: Tested on glass by putting few drops of the formulation on clean glass plate and spreading with plastic pipette, blue to colorless in 8 minutes by exposure to air.

Swiffer WetJet Multi purpose Cleaner by P&G: Tested on glass by putting few drops of the formulation on clean glass plate and spreading with plastic pipette, blue to colorless in 1 minute 30 seconds by exposure to air.

Febreze Fabric refresher with clenzaire by P&G: Tested on fabric (65% Dacron & 35% cotton) by putting few drops of the formulation on white fabric and spreading with plastic pipette, blue to colorless in 2 minutes by exposure to air.

Nexcare spray liquid bandage by 3M.

Spectracide triazicide once done insect killer by Spectrum Group: Tested on glass by putting few drops of the formulation on clean glass plate and spreading with plastic pipette, blue to colorless in 4 minutes by exposure to air.

Spray N Wash Laundry stain remover by Reckitt Benckiser.

WD-40 lubricates, cleans, protects, penetrates and displaces moisture by WD-40.

Loctite professional wood worx bonding and wood glue by Henkel corporation: Tested on wood by putting few drops of the formulation on wood plate and spreading with plastic pipette, blue color remains for 1 day but when water was added next day and rubbed with paper towel, the blue color disappears.

Duck Adhesive remover removes adhesive residue, tar, caulk, gum and crayon by Henkel adhesives.

Meguiar's Gold class car wash shampoo & conditioner by Meguiars: Tested on glass by putting few drops of the formulation on clean glass plate and spreading with plastic pipette, blue to colorless in 12 minutes by exposure to air.

Gamier Fructos Style curl shaping spray gel by Gamier: Tested on glass by putting few drops of the formulation on clean glass plate and spreading with plastic pipette, blue to colorless in 20 minutes by exposure to air.

Windex multi task cleaner with vinegar by SC Johnson: Tested on glass by putting few drops of the formulation on clean glass plate and spreading with plastic pipette, blue to colorless in 50 seconds by exposure to air.

Zymol leather cleaner by Zymol enterprises: Tested on leather by putting few drops of the formulation on leather shoes and spreading with plastic pipette, blue to colorless in 15 seconds by exposure to air.

Armor All car wash concentrate by Armor All/STP Products Company: Tested on glass by putting few drops of the formulation on clean glass plate and spreading with plastic pipette, blue to colorless in 29 minutes by exposure to air.

Meguiar's shine as you dry Quick Wax by Meguar's: Tested on glass by putting few drops of the formulation on clean glass plate and spreading with plastic pipette, blue to colorless in 14 minutes by exposure to air

Armor All original protectant by Armor All/STP Products Company: Tested on glass by putting few drops of the formulation on clean glass plate and spreading with plastic pipette, blue to colorless in 6 minutes by exposure to air.

Armor All extreme tire shine by Armor All/STP Products Company.

Turtle Wax ice synthetic liquid polish by Turtle wax.

J-B Weld adhesive by J-B Weld: Tested on glass by putting few drops of the formulation on clean glass plate and spreading with plastic pipette, blue to colorless in 3 hours 45 minutes by exposure to air.

Fixodent denture adhesive cream by P&G.

Temparin filling material by Dentek Oral Care: Tested on glass by putting few drops of the formulation on clean glass plate and spreading with plastic pipette, blue to colorless in 25 minutes by exposure to air.

Bondo body repair kit by Bondo Corporation.

Bondo-Glass Short Strand fiberglass filler by Bondo: Tested on glass by putting few drops of the formulation on clean glass plate and spreading with plastic pipette, blue to colorless in 37 minutes by exposure to air.

Synthesis of Phenol and Hydrazine Acid-Base Indicators

### EXAMPLE 1

### Synthesis of sodium salt of 5-methyl-2-nitrophenol

A mixture of 5-methyl-2-nitrophenol (0.1M) in ethanol (25 mL, 85%) was stirred followed by addition of sodium hydroxide (0.1M) in ethanol (25 mL, 85%). The reaction mixture was stirred at room temperature for 2 hours. The separated golden yellow solid was filtered, washed with ethanol and dried. Recrystallization from ethanol furnished pure sodium salt in 96% yield.

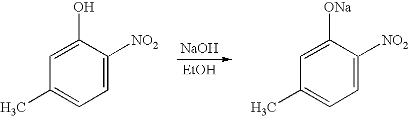

### EXAMPLE 2

### Synthesis of p-nitrobenzhydrazide

A mixture of ethyl p-nitrobenzoate (0.1M), hydrazine hydrate (0.11M) in ethanol (100 mL) was stirred at room temperature for 2 hours. The separated pale yellow solid was filtered, washed with ethanol and dried. Recrystallization from ethanol furnished pure hydrazide in 88% yield.

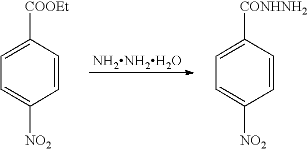

### EXAMPLE 3

### Synthesis of hydrazide

A mixture of ethyl salicylate (0.1M), 2,4-dinitrophenylhydrazine (0.1M) in ethanol (150 mL) was stirred at room temperature for 2 hours. The separated orange solid was filtered, washed with ethanol and dried. Recrystallization from ethanol furnished pure hydrazide in 94% yield.

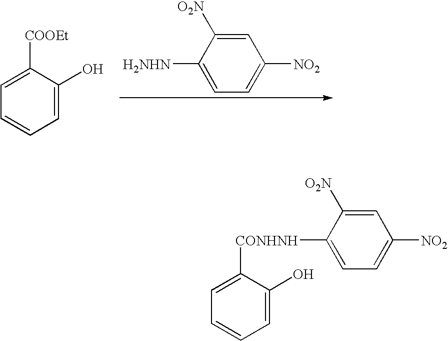

### EXAMPLE 4

### Synthesis of sodium salt of hydrazide

A mixture of hydrazide (0.1M) in ethanol (25 mL) was stirred followed by addition of sodium ethoxide (0.1M) in ethanol (25 mL). The reaction mixture was stirred and refluxed at for 4 hours, cooled to room temperature. The solvent was evaporated on rotary evaporator, isolated the crude yellow product and dried. Recrystallization from ethanol furnished pure sodium salt in 92% yield.

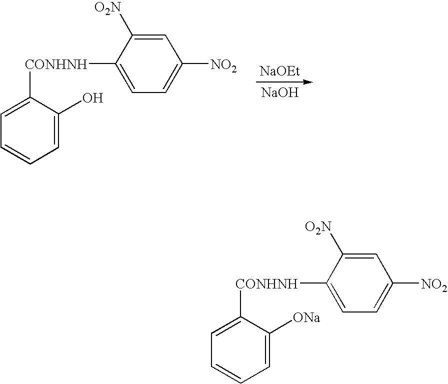

### EXAMPLE 5

### Synthesis of hydrazide

A mixture of ethyl salicylate (0.1M), 4-nitrophenylhydrazine (0.1M) in ethanol (150 mL) was stirred at room temperature for 2 hours. The separated yellow solid was filtered, washed with ethanol and dried. Recrystallization from ethanol furnished pure hydrazide in 89% yield.

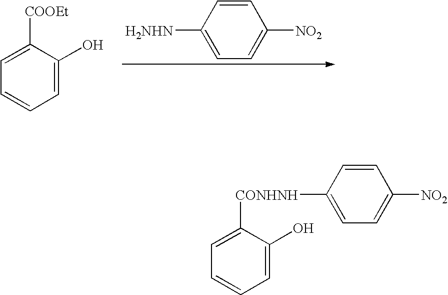

### EXAMPLE 6

### Synthesis of sodium salt of hydrazide

A mixture of hydrazide (0.1M) in ethanol (25 mL) was stirred followed by addition of sodium ethoxide (0.1M) in ethanol (25 mL). The reaction mixture was stirred and refluxed at for 4 hours, cooled to room temperature. The solvent was evaporated on rotary evaporator, isolated the crude yellow product and dried. Recrystallization from ethanol furnished pure sodium salt in 84% yield.

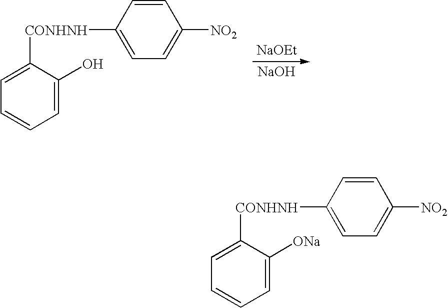

Although the present invention has been described with reference to preferred embodiments, persons skilled in the art will recognize that changes may be made in form and detail without departing from the spirit and scope of the invention.

Those skilled in the art will recognize, or be able to ascertain, using no more than routine experimentation, many equivalents to specific embodiments of the invention described specifically herein. Such equivalents are intended to be encompassed in the scope of the following claims.

We claim:

1. A herbicidal composition comprising:
a herbicide;
an acid-base indicator comprising: 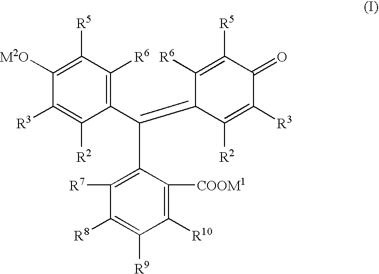
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

2. A liquid plant food composition comprising:
nutrients;
water;
an acid-base indicator comprising: 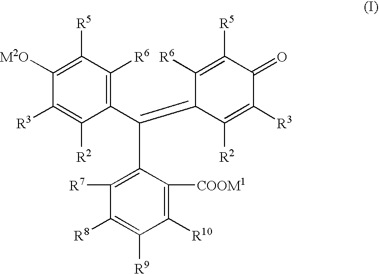
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

3. An animal spray composition comprising:
a tick or flea active agent; and
an acid-base indicator comprising: 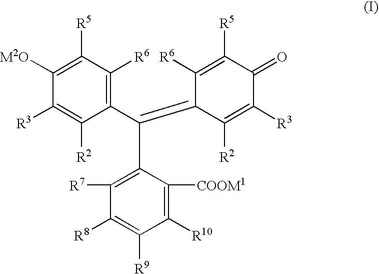
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

4. A fabric refresher comprising:
a fabric refreshing material; and
an acid-base indicator comprising: 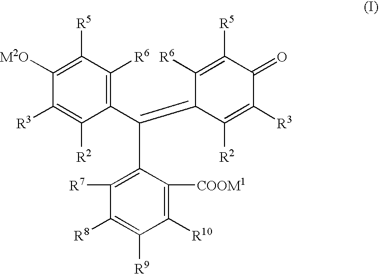
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

5. A liquid bandage composition comprising:
liquid bandage components; and
an acid-base indicator comprising: 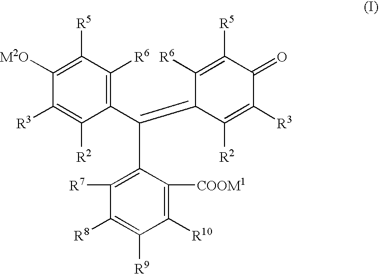
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

6. A glass cleaning composition comprising:
water;
acetic acid;
a surfactant; and
an acid-base indicator comprising: 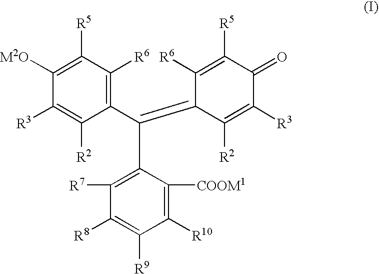
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

7. An automotive wax composition comprising:
a wax; and
an acid-base indicator comprising: 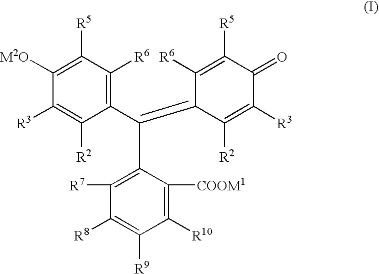
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

8. An automotive wash concentrate composition comprising:
a surfactant;
water; and
an acid-base indicator comprising: 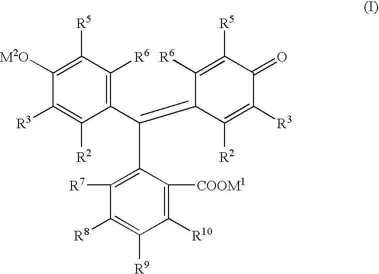
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.
